(19) United States
(12) Patent Application Publication
(10) Pub. No.: US 2021/0377564 A1
(43) Pub. Date: Dec. 2, 2021

(54) METHOD AND APPARATUS OF INTRA PREDICTION MODE SIGNALING

(71) Applicant: Huawei Technologies Co., Ltd., Shenzhen (CN)

(72) Inventors: Alexey Konstantinovich FILIPPOV, Moscow (RU); Vasily Alexeevich RUFITSKIY, Moscow (RU); Jianle CHEN, San Diego, CA (US)

(21) Appl. No.: 17/396,395

(22) Filed: Aug. 6, 2021

Related U.S. Application Data
(63) Continuation of application No. PCT/RU2020/050013, filed on Feb. 7, 2020.
(60) Provisional application No. 62/802,396, filed on Feb. 7, 2019.

(51) Int. Cl. H04N 19/593; H04N 19/176; H04N 19/172; H04N 19/184; H04N 19/186

(52) U.S. Cl. CPC H04N 19/593; H04N 19/176; H04N 19/186; H04N 19/184; H04N 19/172

(57) ABSTRACT

A method determines an intra-prediction mode for decoding a block of a picture encoded in a bitstream. The method includes: inferring a value of an intra-prediction mode of the block to a value indicating a non-angular mode in a case where prediction information associated with the block indicates that the intra-prediction mode is not an angular mode and that intra-sub-partitioning is applied to the block.

### CROSS-REFERENCE TO RELATED APPLICATIONS

This application is a continuation of International Application No. PCT/RU2020/050013, filed on Feb. 7, 2020, which claims priority to U.S. Provisional Patent Application No. 62/802,396, filed Feb. 7, 2019. The disclosures of the aforementioned applications are hereby incorporated by reference in their entireties.

### FIELD

Embodiments of the present application (disclosure) generally relate to the field of picture processing and more particularly to intra prediction mode signaling.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in picture quality are desirable.

### SUMMARY

Embodiments of the present application provide apparatuses and methods for encoding and decoding and intra-prediction mode signaling according to the independent claims.

The present disclosure provides, in a first aspect, a method for determining an intra-prediction mode for decoding a block of a picture encoded in a bitstream, e.g. implemented by a decoding device, the method comprising: inferring a value of an intra-prediction mode of the block to a value indicating a non-angular mode in case prediction information associated with the block indicates that the intra-prediction mode is not an angular mode and that Intra-sub-partitioning, ISP, is applied to the block.

The present disclosure provides an alternative to signaling of intra-prediction information, for example, to be used by decoders and correspondingly encoders when generating the corresponding bitstream instead of the signaling as described in JVET-M0210 or JVET-M0528. According to embodiments of the present disclosure, when or after it is determined that the intra prediction mode of a block is non-angular, an intra sub-partitioning (ISP) flag may serve as an indicator indicating whether an intra prediction mode is PLANAR, or in other words, whether the planar intra prediction mode shall be used for the block. Thus, further explicit intra prediction mode signaling is avoided or in other words the signaling overhead is reduced.

In an implementation form of the method according to the previous aspect as such, the prediction information may comprise or may consist of a flag parsed from the bitstream, or may be derived from other parameters in the bitstream.

In an implementation form of the method according to the previous aspect as such, the flag may be a flag indicating the presence or absence of an angular mode, respectively.

In an implementation form of the method according to any preceding implementation of the previous two aspects or the previous or the previous aspect as such, the flag may be denoted “intra_luma_angular_mode_flag”, wherein for this flag a value of one may indicate an angular mode and a value of zero may indicate a non angular mode.

In this context, for the “intra_luma_angular_mode_flag” and other flags used throughout this disclosure, the meaning of “a value of one” as well as “a value of 1” as well as “a nonzero value” as well as the expression “the intra_luma_angular_mode_flag being true” (and correspondingly for other flags) may be used synonymously throughout the following disclosure and should have the same meaning unless expressly stated otherwise. Likewise, for the “intra_luma_angular_mode_flag” and other flags used throughout this disclosure, the meaning of “a value of zero” as well as “a value of 0” as well as the expression “the intra_luma_angular_mode_flag being false” (and correspondingly for other flags) may be used synonymously throughout the following disclosure and should have the same meaning unless expressly stated otherwise.

In an implementation form of the method according to any one of the second or third aspects or the second or third aspect as such, the flag may be denoted “intra_luma_non_angular_flag”, wherein for this flag a value of zero may indicate an angular mode and a value of one may indicate a non angular mode.

In an implementation form of the method according to any one of the previous aspects or the previous aspect as such, the intra-prediction mode may be the Planar mode or the DC mode, and it may be predetermined or predefined which of the two is to be used for the block.

An implementation form of the method according to any one of the previous aspects or the previous aspect as such, may further comprise: decoding the block based on the inferred value of the intra-prediction mode.

In an implementation form of the method according to any one of the previous aspects or the previous aspect as such, the prediction information indicating that the intra-prediction mode is an angular mode may be a flag indicating whether the intra-prediction mode of the block is a directional mode or not.

In an implementation form of the method according to any one of the previous aspects or the previous aspect as such, the method may further include: parsing an angular mode flag from the bitstream associated to the block to obtain the prediction information, wherein the angular mode flag indicates whether the intra-prediction mode of the block is a directional mode or not.

In an implementation form of the method according to any one of the previous aspects or the previous aspect as such, the method may further include: determining whether ISP is applied to the block or not.

In an implementation form of the method according to any one of the previous aspects or the previous aspect as such, the method may further include: inferring (e.g. not parsing from the bitstream) the prediction information indicating whether ISP is applied to the block based on the prediction information indicating whether multiple reference line, MRL, prediction is applied to the block.

In an implementation form of the method according to the previous aspect as such, the method may further include: inferring (e.g. not parsing from the bitstream) that ISP is not applied to the block when MRL prediction is applied to the block.

In an implementation form of the method according to any one of the previous aspects or the previous aspect as such, the method may further include: parsing a flag from the bitstream indicating whether ISP is applied to the block or not to obtain the prediction information whether ISP is applied to the block or not.

In an implementation form of the method according to any one of the previous aspects or the previous aspect as such, the method may further include: parsing another flag from the bitstream associated to the block indicating whether a planar mode or a DC mode is applied to the block when the prediction information indicates that ISP is not applied to the block.

In an implementation form of the method according to the previous aspect as such, the another flag may be denoted “intra_luma_planar_flag”, wherein a value one of this flag indicates the Planar mode and a value zero indicates the DC mode.

In an implementation form of the method according to any one of the previous aspects or the previous aspect as such, the method may further include: obtaining the value of the intra prediction mode from a most probable modes, MPM, list when the prediction information associated to the block indicates that the intra-prediction mode is an angular mode.

In an implementation form of the method according to the previous aspect as such, the method may further include decoding the block using the obtained value of the intra prediction mode.

In an eighteenth aspect of the present disclosure, the method according to any one of the previous aspects or the previous aspect as such may further include: determining that the prediction information associated to the block indicates that the intra-prediction mode is not an angular mode and that ISP is applied to the block at once or in parallel; or determining first that the prediction information associated to the block indicates that the intra-prediction mode is not an angular mode, and afterwards determining that ISP is applied to the block.

The present disclosure further provides a nineteenth aspect of a method of coding implemented by a coding device, comprising parsing a bitstream for an intra prediction mode for decoding a block of a picture encoded in the bitstream, wherein the method comprises: obtaining a value of a flag denoted “intra_luma_angular_mode_flag” from the bitstream, wherein that value of the flag indicates whether the intra prediction mode obtained by parsing the bitstream and used to intra-predict the block is a directional intra-prediction mode or not; obtaining an index value within a most probable modes, MPM, list in case the value of the flag “intra_luma_angular_mode_flag” is nonzero; determining whether intra sub-partitioning, ISP, is applied to the block, and in case ISP is not applied to the block, the intra prediction mode is determined on the basis of additional signaling, or otherwise, in case ISP is applied to the block, the intra prediction mode for the block is set to PLANAR intra prediction.

Similar as described above, the present disclosure provides an alternative to signaling of intra-prediction information, for example, to be used by coding devices for decoding and correspondingly coding devices for encoding when generating the corresponding bitstream instead of the signaling as described in JVET-M0210 or JVET-M0528. According to embodiments of the present disclosure, when or after it is determined that the intra prediction mode of a block is non-angular, an ISP flag may serve as an indicator indicating whether an intra prediction mode is PLANAR, or in other words, whether the planar intra prediction mode shall be used for the block. Thus further explicit intra prediction mode signaling is avoided or in other words the signaling overhead is reduced.

The present disclosure further provides a twentieth aspect of a method for coding an intra prediction mode of a block of a picture into a bitstream, e.g. implemented by an encoding device, wherein the method comprises: encoding a value of a flag denoted “intra_luma_angular_mode_flag” into the bitstream, wherein that value of the flag indicates whether the intra prediction mode used to intra-predict the block is a directional intra-prediction mode or not; encoding an index value within a most probable modes, MPM, list into the bitstream, in case the value of the flag “intra_luma_angular_mode_flag” is nonzero; determining whether intra sub-partitioning, ISP, is applied to the block, and in case ISP is not applied to the block, the intra prediction mode is encoded on the basis of additional signaling, or otherwise, in case ISP is applied to the block, the intra prediction mode for the block is set to PLANAR intra prediction.

The advantages of the before-mentioned method of coding implemented by a coding device, i.e. an encoding device, are the same as for the before-mentioned method of coding implemented by a coding device, namely allowing to reduce the signaling overhead respectively reducing the bandwidth required for transmitting the encoded video or reducing the memory required for storing the encoded video data . . . .

A twenty-first aspect of the present disclosure provides an implementation form of the method according to any one of the previous two aspects or the previous aspects as such, wherein another flag may be encoded indicating whether ISP should be applied to the block in order to get the values of reconstructed samples, and determination of whether ISP is applied to the block is performed on the base of signaling within a bitstream.

A twenty-second aspect of the present disclosure provides an implementation form of the method according to any one of the previous three aspects or the previous aspect as such, wherein the additional signaling is used to signal intra prediction mode by signaling the value of the another flag denoted “intra_luma_planar_flag” when ISP is not applied to the block.

A twenty-third aspect of the present disclosure provides an implementation form of the method according to any one of the previous four aspects or the previous aspect as such, wherein when MRL is applied to the block and ISP is not applied to the block, ISP flag is not signaled in the bitstream.

The present disclosure further provides an encoder comprising processing circuitry for carrying out the method according to the previous twentieth aspect, and according to any one of the previous twenty-first to twenty-third aspect when depending on the twentieth aspect.

The present disclosure further provides a decoder comprising processing circuitry for carrying out the method according to any one of the previous first to nineteenth aspects, and according to any one of the previous twenty-first to twenty-third aspects, when depending on the nineteenth aspect.

The present disclosure further provides a decoder for determining an intra-prediction mode for decoding a block of a picture encoded in a bitstream, comprising: an inferring unit for inferring a value of an intra-prediction mode of the block to a value indicating a non-angular mode in case prediction information associated with the block indicates that the intra-prediction mode is not an angular mode and that Intra-sub-partitioning, ISP, is applied to the block.

The present disclosure further provides an encoder for determining an intra-prediction mode for decoding a block of a picture encoded in a bitstream, the method comprising: an inferring unit for inferring a value of an intra-prediction mode of the block to a value indicating a non-angular mode in case prediction information associated with the block indicates that the intra-prediction mode is not an angular mode and that Intra-sub-partitioning, ISP, is applied to the block.

The present disclosure further provides a coding device, comprising a parsing unit for parsing a bitstream for an intra prediction mode for decoding a block of a picture encoded in the bitstream; wherein. the coding device further comprises a first obtaining unit for obtaining a value of a flag denoted “intra_luma_angular_mode_flag” from the bitstream, a first determining unit for determining that value of the flag indicates whether the intra prediction mode obtained by parsing the bitstream and used to intra-predict the block is a directional intra-prediction mode or not; a second obtaining unit for obtaining an index value within a most probable modes, MPM, list in case the value of the flag “intra_luma_angular_mode_flag” is nonzero; otherwise in case the first determining unit has determined the value of the flag “intra_luma_angular_mode_flag” is zero: a second determining unit for determining whether intra sub-partitioning, ISP, is applied to the block, and in case ISP is not applied to the block: a third obtaining unit for obtaining an “intra_luma_planar_flag”, and a second determining unit for determining the intra prediction mode on the basis of additional signaling, or otherwise, in case ISP is applied to the block, a setting unit for setting the intra prediction mode for the block set to PLANAR intra prediction.

The present disclosure further provides a coding device, comprising: a coding unit for coding an intra prediction mode for a block of a picture encoded in a bitstream, a first encoding unit for encoding a value of a flag denoted “intra_luma_angular_mode_flag” into the bitstream, a first determining unit for determining that the value of the flag indicates whether the intra prediction mode used to intra-predict the block is a directional intra-prediction mode or not; a second encoding unit for encoding an index value within a most probable modes, MPM, list into the bitstream, in case the value of the flag “intra_luma_angular_mode_flag” is nonzero, otherwise in case the first determining unit has determined the value of the flag “intra_luma_angular_mode_flag” is zero: a second determining unit for determining whether intra sub-partitioning, ISP, is applied to the block, and in case ISP is not applied to the block, an obtaining unit for obtaining an “intra_luma_planar_flag”, and a third encoding unit for encoding the intra prediction mode on the basis of additional signaling, or otherwise, in case ISP is applied to the block, a setting unit for setting the intra prediction mode for the block to PLANAR intra prediction.

The present disclosure further provides a computer program product comprising a program code for performing the method according to any one of the previous first to twenty-third aspects.

The present disclosure also provides a decoder, comprising: one or more processors; and a non-transitory computer-readable storage medium coupled to the processors and storing programming for execution by the processors, wherein the programming, when executed by the processors, configures the decoder to carry out the method according to any one of the previous first to nineteenth aspects, and according to any one of the previous twenty-first to twenty-third aspects when depending on the nineteenth aspect.

The present disclosure also provides an encoder, comprising: one or more processors; and a non-transitory computer-readable storage medium coupled to the processors and storing programming for execution by the processors, wherein the programming, when executed by the processors, configures the encoder to carry out the method according to the twentieth aspect, and according to any one of the twenty-first to twenty-third aspects when depending on the twentieth aspect.

Details of one or more embodiments are set forth in the accompanying drawings and the description below. Other features, objects, and advantages will be apparent from the description, drawings, and claims.

### BRIEF DESCRIPTION OF THE DRAWINGS

In the following, exemplary embodiments of the disclosure are described in more detail with reference to the attached figures and drawings, in which:

FIG. 1A is a block diagram showing an example of a video coding system configured to implement embodiments of the disclosure;

FIG. 1B is a block diagram showing another example of a video coding system configured to implement embodiments of the disclosure;

FIG. 2 is a block diagram showing an example of a video encoder configured to implement embodiments of the disclosure;

FIG. 3 is a block diagram showing an example structure of a video decoder configured to implement embodiments of the disclosure;

FIG. 4 is a block diagram illustrating an example of an encoding apparatus or a decoding apparatus;

FIG. 5 is a block diagram illustrating another example of an encoding apparatus or a decoding apparatus;

FIG. 6 shows angular intra prediction directions and the associated intra-prediction modes in HEVC;

FIG. 7 shows angular intra prediction directions and the associated intra-prediction modes in JEM;

FIG. 8 shows angular intra prediction directions and the associated intra-prediction modes in VTM-3.0 and VVC specification draft v.3;

FIG. 9 is an illustration of horizontal and vertical binary splits performed by an Intra SubPartitioning (ISP) tool;

FIG. 10 is an illustration of two-level horizontal and vertical binary splits performed by Intra SubPartitioning (ISP) tool;

FIG. 11 is a flowchart of restoring intra prediction mode from a bitstream where PLANAR and DC intra prediction mode are restored in accordance with whether ISP is applied to the block or not;

FIG. 12 is a flowchart of coding an intra prediction mode for a block of a picture encoded in a bitstream where PLANAR and DC intra prediction mode are coded in accordance with whether ISP is applied to the block or not;

FIG. 13 is a schematic depiction of a decoder according to the present disclosure;

FIG. 14 is a schematic depiction of an encoder according to the present disclosure;

FIG. 15 is a schematic depiction of a coding device for decoding according to the present disclosure;

FIG. 16 is a schematic depiction of a coding device for encoding according to the present disclosure.

In the following identical reference signs refer to identical or at least functionally equivalent features if not explicitly specified otherwise.

### DETAILED DESCRIPTION

In the following description, reference is made to the accompanying figures, which form part of the disclosure, and which show, by way of illustration, exemplary aspects of embodiments of the disclosure or exemplary aspects in which embodiments of the present disclosure may be used. It is understood that embodiments of the disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Video coding typically refers to the processing of a sequence of pictures, which form the video or video sequence. Instead of the term “picture”, the term “frame” or “image” may be used as synonyms in the field of video coding. Video coding (or coding in general) comprises two parts: video encoding and video decoding. Video encoding is performed at the source side, typically comprising processing (e.g. by compression) the original video pictures to reduce the amount of data required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general) shall be understood to relate to “encoding” or “decoding” of video pictures or respective video sequences. The combination of the encoding part and the decoding part is also referred to as CODEC (Coding and Decoding).

In case of lossless video coding, the original video pictures can be reconstructed, i.e. the reconstructed video pictures have the same quality as the original video pictures (assuming no transmission loss or other data loss during storage or transmission). In case of lossy video coding, further compression, e.g. by quantization, is performed, to reduce the amount of data representing the video pictures, which cannot be completely reconstructed at the decoder, i.e. the quality of the reconstructed video pictures is lower or worse compared to the quality of the original video pictures.

Several video coding standards belong to the group of “lossy hybrid video codecs” (i.e. combine spatial and temporal prediction in the sample domain and 2D transform coding for applying quantization in the transform domain). Each picture of a video sequence is typically partitioned into a set of non-overlapping blocks and the coding is typically performed on a block level. In other words, at the encoder the video is typically processed, i.e. encoded, on a block (video block) level, e.g. by using spatial (intra picture) prediction and/or temporal (inter picture) prediction to generate a prediction block, subtracting the prediction block from the current block (block currently processed/to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation. Furthermore, the encoder duplicates the decoder processing loop such that both will generate identical predictions (e.g. intra- and inter predictions) and/or re-constructions for processing, i.e. coding, the subsequent blocks.

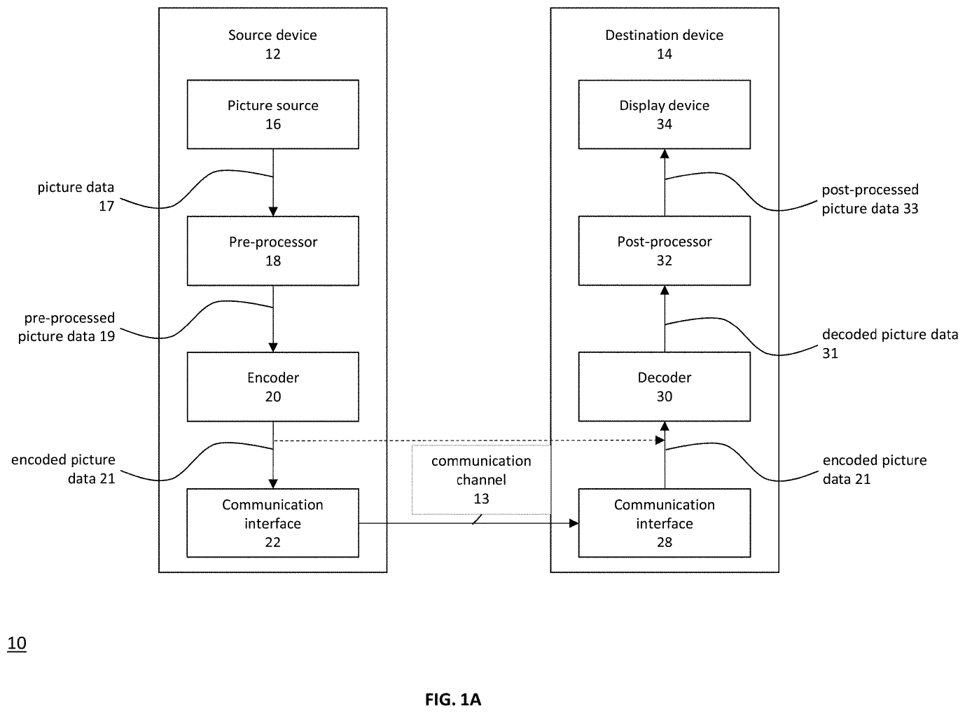

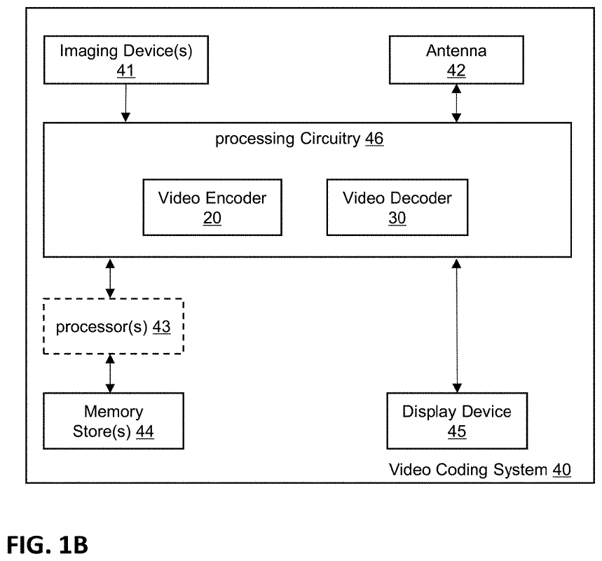

In the following embodiments of a video coding system 10, a video encoder 20 and a video decoder 30 are described based on FIGS. 1 to 3.

FIG. 1A is a schematic block diagram illustrating an example coding system 10, e.g. a video coding system 10 (or short coding system 10) that may utilize techniques of this present application. Video encoder 20 (or short encoder 20) and video decoder 30 (or short decoder 30) of video coding system 10 represent examples of devices that may be configured to perform techniques in accordance with various examples described in the present application.

As shown in FIG. 1A, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component.

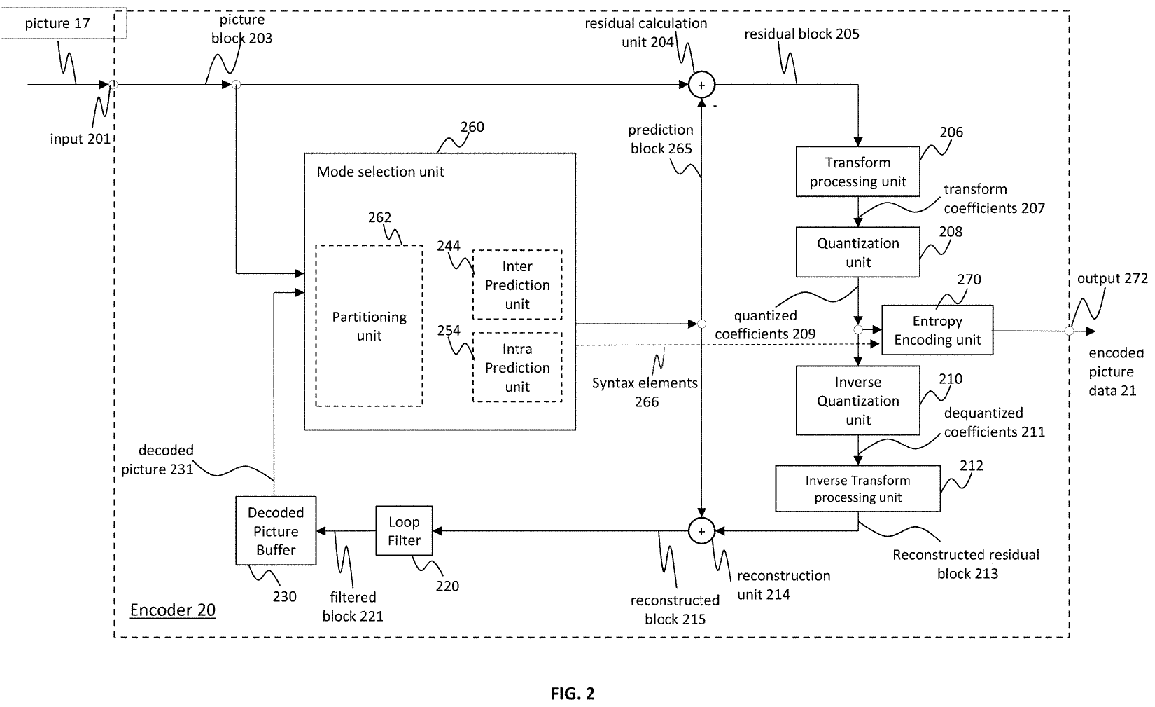

The video encoder 20 is configured to receive the pre-processed picture data 19 and provide encoded picture data 21 (further details will be described below, e.g., based on FIG. 2).

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 1A pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission.

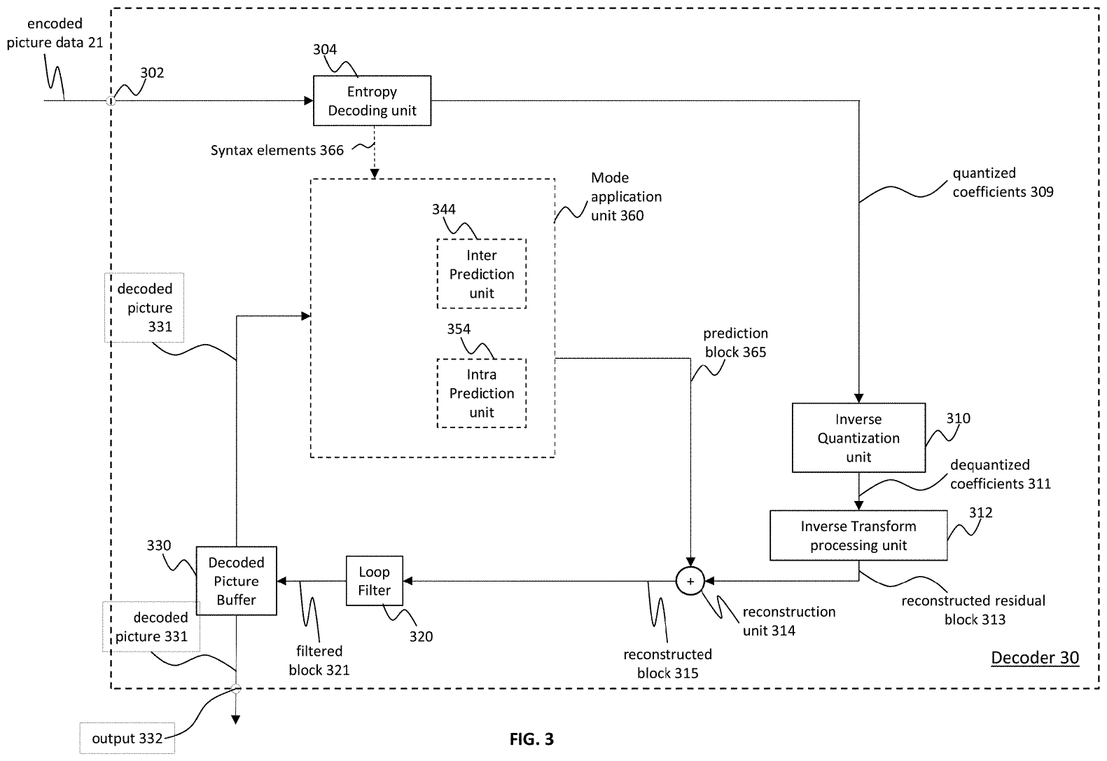

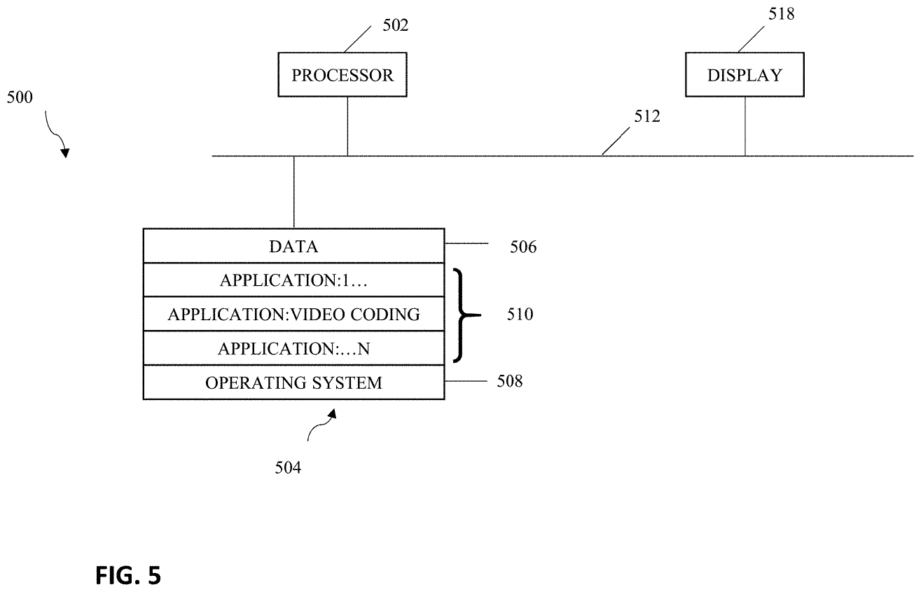

The decoder 30 is configured to receive the encoded picture data 21 and provide decoded picture data 31 or a decoded picture 31 (further details will be described below, e.g., based on FIG. 3 or FIG. 5).

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 1A depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 1A may vary depending on the actual device and application.

The encoder 20 (e.g. a video encoder 20) or the decoder 30 (e.g. a video decoder 30) or both encoder 20 and decoder 30 may be implemented via processing circuitry as shown in FIG. 1B, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules as discussed with respect to encoder 20 of FIG. 2 and/or any other encoder system or subsystem described herein. The decoder 30 may be implemented via processing circuitry 46 to embody the various modules as discussed with respect to decoder 30 of FIG. 3 and/or any other decoder system or subsystem described herein. The processing circuitry may be configured to perform the various operations as discussed later. As shown in FIG. 5, if the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 1B.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 1A is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

For convenience of description, embodiments of the disclosure are described herein, for example, by reference to High-Efficiency Video Coding (HEVC) or to the reference software of Versatile Video coding (VVC), the next generation video coding standard developed by the Joint Collaboration Team on Video Coding (JCT-VC) of ITU-T Video Coding Experts Group (VCEG) and ISO/IEC Motion Picture Experts Group (MPEG). One of ordinary skill in the art will understand that embodiments of the disclosure are not limited to HEVC or VVC.

Encoder and Encoding Method

FIG. 2 shows a schematic block diagram of an example video encoder 20 that is configured to implement the techniques of the present application. In the example of FIG. 2, the video encoder 20 comprises an input 201 (or input interface 201), a residual calculation unit 204, a transform processing unit 206, a quantization unit 208, an inverse quantization unit 210, and inverse transform processing unit 212, a reconstruction unit 214, a loop filter unit 220, a decoded picture buffer (DPB) 230, a mode selection unit 260, an entropy encoding unit 270 and an output 272 (or output interface 272). The mode selection unit 260 may include an inter prediction unit 244, an intra prediction unit 254 and a partitioning unit 262. Inter prediction unit 244 may include a motion estimation unit and a motion compensation unit (not shown). A video encoder 20 as shown in FIG. 2 may also be referred to as hybrid video encoder or a video encoder according to a hybrid video codec.

The residual calculation unit 204, the transform processing unit 206, the quantization unit 208, the mode selection unit 260 may be referred to as forming a forward signal path of the encoder 20, whereas the inverse quantization unit 210, the inverse transform processing unit 212, the reconstruction unit 214, the buffer 216, the loop filter 220, the decoded picture buffer (DPB) 230, the inter prediction unit 244 and the intra-prediction unit 254 may be referred to as forming a backward signal path of the video encoder 20, wherein the backward signal path of the video encoder 20 corresponds to the signal path of the decoder (see video decoder 30 in FIG. 3). The inverse quantization unit 210, the inverse transform processing unit 212, the reconstruction unit 214, the loop filter 220, the decoded picture buffer (DPB) 230, the inter prediction unit 244 and the intra-prediction unit 254 are also referred to forming the “built-in decoder” of video encoder 20.

Pictures & Picture Partitioning (Pictures & Blocks)

The encoder 20 may be configured to receive, e.g. via input 201, a picture 17 (or picture data 17), e.g. picture of a sequence of pictures forming a video or video sequence. The received picture or picture data may also be a pre-processed picture 19 (or pre-processed picture data 19). For sake of simplicity the following description refers to the picture 17. The picture 17 may also be referred to as current picture or picture to be coded (in particular in video coding to distinguish the current picture from other pictures, e.g. previously encoded and/or decoded pictures of the same video sequence, i.e. the video sequence which also comprises the current picture).

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RBG format or color space a picture comprises a corresponding red, green and blue sample array. However, in video coding each pixel is typically represented in a luminance and chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array. Accordingly, a picture may be, for example, an array of luma samples in monochrome format or an array of luma samples and two corresponding arrays of chroma samples in 4:2:0, 4:2:2, and 4:4:4 colour format.

Embodiments of the video encoder 20 may comprise a picture partitioning unit (not depicted in FIG. 2) configured to partition the picture 17 into a plurality of (typically non-overlapping) picture blocks 203. These blocks may also be referred to as root blocks, macro blocks (H.264/AVC) or coding tree blocks (CTB) or coding tree units (CTU) (H.265/HEVC and VVC). The picture partitioning unit may be configured to use the same block size for all pictures of a video sequence and the corresponding grid defining the block size, or to change the block size between pictures or subsets or groups of pictures, and partition each picture into the corresponding blocks.

In further embodiments, the video encoder may be configured to receive directly a block 203 of the picture 17, e.g. one, several or all blocks forming the picture 17. The picture block 203 may also be referred to as current picture block or picture block to be coded.

Like the picture 17, the picture block 203 again is or can be regarded as a two-dimensional array or matrix of samples with intensity values (sample values), although of smaller dimension than the picture 17. In other words, the block 203 may comprise, e.g., one sample array (e.g. a luma array in case of a monochrome picture 17, or a luma or chroma array in case of a color picture) or three sample arrays (e.g. a luma and two chroma arrays in case of a color picture 17) or any other number and/or kind of arrays depending on the color format applied. The number of samples in horizontal and vertical direction (or axis) of the block 203 define the size of block 203. Accordingly, a block may, for example, an M×N (M-column by N-row) array of samples, or an M×N array of transform coefficients.

Embodiments of the video encoder 20 as shown in FIG. 2 may be configured to encode the picture 17 block by block, e.g. the encoding and prediction is performed per block 203.

Embodiments of the video encoder 20 as shown in FIG. 2 may be further configured to partition and/or encode the picture by using slices (also referred to as video slices), wherein a picture may be partitioned into or encoded using one or more slices (typically non-overlapping), and each slice may comprise one or more blocks (e.g. CTUs).

Embodiments of the video encoder 20 as shown in FIG. 2 may be further configured to partition and/or encode the picture by using tile groups (also referred to as video tile groups) and/or tiles (also referred to as video tiles), wherein a picture may be partitioned into or encoded using one or more tile groups (typically non-overlapping), and each tile group may comprise, e.g. one or more blocks (e.g. CTUs) or one or more tiles, wherein each tile, e.g. may be of rectangular shape and may comprise one or more blocks (e.g. CTUs), e.g. complete or fractional blocks.

Residual Calculation

The residual calculation unit 204 may be configured to calculate a residual block 205 (also referred to as residual 205) based on the picture block 203 and a prediction block 265 (further details about the prediction block 265 are provided later), e.g. by subtracting sample values of the prediction block 265 from sample values of the picture block 203, sample by sample (pixel by pixel) to obtain the residual block 205 in the sample domain.

Transform

The transform processing unit 206 may be configured to apply a transform, e.g. a discrete cosine transform (DCT) or discrete sine transform (DST), on the sample values of the residual block 205 to obtain transform coefficients 207 in a transform domain. The transform coefficients 207 may also be referred to as transform residual coefficients and represent the residual block 205 in the transform domain.

The transform processing unit 206 may be configured to apply integer approximations of DCT/DST, such as the transforms specified for H.265/HEVC. Compared to an orthogonal DCT transform, such integer approximations are typically scaled by a certain factor. In order to preserve the norm of the residual block which is processed by forward and inverse transforms, additional scaling factors are applied as part of the transform process. The scaling factors are typically chosen based on certain constraints like scaling factors being a power of two for shift operations, bit depth of the transform coefficients, tradeoff between accuracy and implementation costs, etc. Specific scaling factors are, for example, specified for the inverse transform, e.g. by inverse transform processing unit 212 (and the corresponding inverse transform, e.g. by inverse transform processing unit 312 at video decoder 30) and corresponding scaling factors for the forward transform, e.g. by transform processing unit 206, at an encoder 20 may be specified accordingly.

Embodiments of the video encoder 20 (respectively transform processing unit 206) may be configured to output transform parameters, e.g. a type of transform or transforms, e.g. directly or encoded or compressed via the entropy encoding unit 270, so that, e.g., the video decoder 30 may receive and use the transform parameters for decoding.

Quantization

The quantization unit 208 may be configured to quantize the transform coefficients 207 to obtain quantized coefficients 209, e.g. by applying scalar quantization or vector quantization. The quantized coefficients 209 may also be referred to as quantized transform coefficients 209 or quantized residual coefficients 209.

The quantization process may reduce the bit depth associated with some or all of the transform coefficients 207. For example, an n-bit transform coefficient may be rounded down to an m-bit Transform coefficient during quantization, where n is greater than m. The degree of quantization may be modified by adjusting a quantization parameter (QP). For example for scalar quantization, different scaling may be applied to achieve finer or coarser quantization. Smaller quantization step sizes correspond to finer quantization, whereas larger quantization step sizes correspond to coarser quantization. The applicable quantization step size may be indicated by a quantization parameter (QP). The quantization parameter may for example be an index to a predefined set of applicable quantization step sizes. For example, small quantization parameters may correspond to fine quantization (small quantization step sizes) and large quantization parameters may correspond to coarse quantization (large quantization step sizes) or vice versa. The quantization may include division by a quantization step size and a corresponding and/or the inverse dequantization, e.g. by inverse quantization unit 210, may include multiplication by the quantization step size. Embodiments according to some standards, e.g. HEVC, may be configured to use a quantization parameter to determine the quantization step size. Generally, the quantization step size may be calculated based on a quantization parameter using a fixed point approximation of an equation including division. Additional scaling factors may be introduced for quantization and dequantization to restore the norm of the residual block, which might get modified because of the scaling used in the fixed point approximation of the equation for quantization step size and quantization parameter. In one example implementation, the scaling of the inverse transform and dequantization might be combined. Alternatively, customized quantization tables may be used and signaled from an encoder to a decoder, e.g. in a bitstream. The quantization is a lossy operation, wherein the loss increases with increasing quantization step sizes.

Embodiments of the video encoder 20 (respectively quantization unit 208) may be configured to output quantization parameters (QP), e.g. directly or encoded via the entropy encoding unit 270, so that, e.g., the video decoder 30 may receive and apply the quantization parameters for decoding.

Inverse Quantization

The inverse quantization unit 210 is configured to apply the inverse quantization of the quantization unit 208 on the quantized coefficients to obtain dequantized coefficients 211, e.g. by applying the inverse of the quantization scheme applied by the quantization unit 208 based on or using the same quantization step size as the quantization unit 208. The dequantized coefficients 211 may also be referred to as dequantized residual coefficients 211 and correspond—although typically not identical to the transform coefficients due to the loss by quantization—to the transform coefficients 207.

Inverse Transform

The inverse transform processing unit 212 is configured to apply the inverse transform of the transform applied by the transform processing unit 206, e.g. an inverse discrete cosine transform (DCT) or inverse discrete sine transform (DST) or other inverse transforms, to obtain a reconstructed residual block 213 (or corresponding dequantized coefficients 213) in the sample domain. The reconstructed residual block 213 may also be referred to as transform block 213.

Reconstruction

The reconstruction unit 214 (e.g. adder or summer 214) is configured to add the transform block 213 (i.e. reconstructed residual block 213) to the prediction block 265 to obtain a reconstructed block 215 in the sample domain, e.g. by adding—sample by sample—the sample values of the reconstructed residual block 213 and the sample values of the prediction block 265.

Filtering

The loop filter unit 220 (or short “loop filter” 220), is configured to filter the reconstructed block 215 to obtain a filtered block 221, or in general, to filter reconstructed samples to obtain filtered samples. The loop filter unit is, e.g., configured to smooth pixel transitions, or otherwise improve the video quality. The loop filter unit 220 may comprise one or more loop filters such as a de-blocking filter, a sample-adaptive offset (SAO) filter or one or more other filters, e.g. a bilateral filter, an adaptive loop filter (ALF), a sharpening, a smoothing filters or a collaborative filters, or any combination thereof. Although the loop filter unit 220 is shown in FIG. 2 as being an in loop filter, in other configurations, the loop filter unit 220 may be implemented as a post loop filter. The filtered block 221 may also be referred to as filtered reconstructed block 221.

Embodiments of the video encoder 20 (respectively loop filter unit 220) may be configured to output loop filter parameters (such as sample adaptive offset information), e.g. directly or encoded via the entropy encoding unit 270, so that, e.g., a decoder 30 may receive and apply the same loop filter parameters or respective loop filters for decoding.

Decoded Picture Buffer

The decoded picture buffer (DPB) 230 may be a memory that stores reference pictures, or in general reference picture data, for encoding video data by video encoder 20. The DPB 230 may be formed by any of a variety of memory devices, such as dynamic random access memory (DRAM), including synchronous DRAM (SDRAM), magnetoresistive RAM (MRAM), resistive RAM (RRAM), or other types of memory devices. The decoded picture buffer (DPB) 230 may be configured to store one or more filtered blocks 221. The decoded picture buffer 230 may be further configured to store other previously filtered blocks, e.g. previously reconstructed and filtered blocks 221, of the same current picture or of different pictures, e.g. previously reconstructed pictures, and may provide complete previously reconstructed, i.e. decoded, pictures (and corresponding reference blocks and samples) and/or a partially reconstructed current picture (and corresponding reference blocks and samples), for example for inter prediction. The decoded picture buffer (DPB) 230 may be also configured to store one or more unfiltered reconstructed blocks 215, or in general unfiltered reconstructed samples, e.g. if the reconstructed block 215 is not filtered by loop filter unit 220, or any other further processed version of the reconstructed blocks or samples.

Mode Selection (Partitioning & Prediction)

The mode selection unit 260 comprises partitioning unit 262, inter-prediction unit 244 and intra-prediction unit 254, and is configured to receive or obtain original picture data, e.g. an original block 203 (current block 203 of the current picture 17), and reconstructed picture data, e.g. filtered and/or unfiltered reconstructed samples or blocks of the same (current) picture and/or from one or a plurality of previously decoded pictures, e.g. from decoded picture buffer 230 or other buffers (e.g. line buffer, not shown) . . . . The reconstructed picture data is used as reference picture data for prediction, e.g. inter-prediction or intra-prediction, to obtain a prediction block 265 or predictor 265.

Mode selection unit 260 may be configured to determine or select a partitioning for a current block prediction mode (including no partitioning) and a prediction mode (e.g. an intra or inter prediction mode) and generate a corresponding prediction block 265, which is used for the calculation of the residual block 205 and for the reconstruction of the reconstructed block 215.

Embodiments of the mode selection unit 260 may be configured to select the partitioning and the prediction mode (e.g. from those supported by or available for mode selection unit 260), which provide the best match or in other words the minimum residual (minimum residual means better compression for transmission or storage), or a minimum signaling overhead (minimum signaling overhead means better compression for transmission or storage), or which considers or balances both. The mode selection unit 260 may be configured to determine the partitioning and prediction mode based on rate distortion optimization (RDO), i.e. select the prediction mode which provides a minimum rate distortion. Terms like “best”, “minimum”, “optimum” etc. in this context do not necessarily refer to an overall “best”, “minimum”, “optimum”, etc. but may also refer to the fulfillment of a termination or selection criterion like a value exceeding or falling below a threshold or other constraints leading potentially to a “sub-optimum selection” but reducing complexity and processing time.

In other words, the partitioning unit 262 may be configured to partition the block 203 into smaller block partitions or sub-blocks (which form again blocks), e.g. iteratively using quad-tree-partitioning (QT), binary partitioning (BT) or triple-tree-partitioning (TT) or any combination thereof, and to perform, e.g., the prediction for each of the block partitions or sub-blocks, wherein the mode selection comprises the selection of the tree-structure of the partitioned block 203 and the prediction modes are applied to each of the block partitions or sub-blocks.

In the following the partitioning (e.g. by partitioning unit 260) and prediction processing (by inter-prediction unit 244 and intra-prediction unit 254) performed by an example video encoder 20 will be explained in more detail.

Partitioning

The partitioning unit 262 may partition (or split) a current block 203 into smaller partitions, e.g. smaller blocks of square or rectangular size. These smaller blocks (which may also be referred to as sub-blocks) may be further partitioned into even smaller partitions. This is also referred to tree-partitioning or hierarchical tree-partitioning, wherein a root block, e.g. at root tree-level 0 (hierarchy-level 0, depth 0), may be recursively partitioned, e.g. partitioned into two or more blocks of a next lower tree-level, e.g. nodes at tree-level 1 (hierarchy-level 1, depth 1), wherein these blocks may be again partitioned into two or more blocks of a next lower level, e.g. tree-level 2 (hierarchy-level 2, depth 2), etc. until the partitioning is terminated, e.g. because a termination criterion is fulfilled, e.g. a maximum tree depth or minimum block size is reached. Blocks which are not further partitioned are also referred to as leaf-blocks or leaf nodes of the tree. A tree using partitioning into two partitions is referred to as binary-tree (BT), a tree using partitioning into three partitions is referred to as ternary-tree (TT), and a tree using partitioning into four partitions is referred to as quad-tree (QT).

As mentioned before, the term “block” as used herein may be a portion, in particular a square or rectangular portion, of a picture. With reference, for example, to HEVC and VVC, the block may be or correspond to a coding tree unit (CTU), a coding unit (CU), prediction unit (PU), and transform unit (TU) and/or to the corresponding blocks, e.g. a coding tree block (CTB), a coding block (CB), a transform block (TB) or prediction block (PB).

For example, a coding tree unit (CTU) may be or comprise a CTB of luma samples, two corresponding CTBs of chroma samples of a picture that has three sample arrays, or a CTB of samples of a monochrome picture or a picture that is coded using three separate colour planes and syntax structures used to code the samples. Correspondingly, a coding tree block (CTB) may be an N×N block of samples for some value of N such that the division of a component into CTBs is a partitioning. A coding unit (CU) may be or comprise a coding block of luma samples, two corresponding coding blocks of chroma samples of a picture that has three sample arrays, or a coding block of samples of a monochrome picture or a picture that is coded using three separate colour planes and syntax structures used to code the samples. Correspondingly a coding block (CB) may be an M×N block of samples for some values of M and N such that the division of a CTB into coding blocks is a partitioning.

In embodiments, e.g., according to HEVC, a coding tree unit (CTU) may be split into CUs by using a quad-tree structure denoted as coding tree. The decision whether to code a picture area using inter-picture (temporal) or intra-picture (spatial) prediction is made at the CU level. Each CU can be further split into one, two or four PUs according to the PU splitting type. Inside one PU, the same prediction process is applied and the relevant information is transmitted to the decoder on a PU basis. After obtaining the residual block by applying the prediction process based on the PU splitting type, a CU can be partitioned into transform units (TUs) according to another quadtree structure similar to the coding tree for the CU.

In embodiments, e.g., according to the latest video coding standard currently in development, which is referred to as Versatile Video Coding (VVC), a combined Quad-tree and binary tree (QTBT) partitioning is for example used to partition a coding block. In the QTBT block structure, a CU can have either a square or rectangular shape. For example, a coding tree unit (CTU) is first partitioned by a quadtree structure. The quadtree leaf nodes are further partitioned by a binary tree or ternary (or triple) tree structure. The partitioning tree leaf nodes are called coding units (CUs), and that segmentation is used for prediction and transform processing without any further partitioning. This means that the CU, PU and TU have the same block size in the QTBT coding block structure. In parallel, multiple partition, for example, triple tree partition may be used together with the QTBT block structure.

In one example, the mode selection unit 260 of video encoder 20 may be configured to perform any combination of the partitioning techniques described herein.

As described above, the video encoder 20 is configured to determine or select the best or an optimum prediction mode from a set of (e.g. pre-determined) prediction modes. The set of prediction modes may comprise, e.g., intra-prediction modes and/or inter-prediction modes.

Intra-Prediction

The set of intra-prediction modes may comprise 35 different intra-prediction modes, e.g. non-directional modes like DC (or mean) mode and planar mode, or directional modes, e.g. as defined in HEVC, or may comprise 67 different intra-prediction modes, e.g. non-directional modes like DC (or mean) mode and planar mode, or directional modes, e.g. as defined for VVC.

The intra-prediction unit 254 is configured to use reconstructed samples of neighboring blocks of the same current picture to generate an intra-prediction block 265 according to an intra-prediction mode of the set of intra-prediction modes.

The intra prediction unit 254 (or in general the mode selection unit 260) is further configured to output intra-prediction parameters (or in general information indicative of the selected intra prediction mode for the block) to the entropy encoding unit 270 in form of syntax elements 266 for inclusion into the encoded picture data 21, so that, e.g., the video decoder 30 may receive and use the prediction parameters for decoding.

Inter-Prediction

The set of (or possible) inter-prediction modes depends on the available reference pictures (i.e. previous at least partially decoded pictures, e.g. stored in DBP 230) and other inter-prediction parameters, e.g. whether the whole reference picture or only a part, e.g. a search window area around the area of the current block, of the reference picture is used for searching for a best matching reference block, and/or e.g. whether pixel interpolation is applied, e.g. half/semi-pel and/or quarter-pel interpolation, or not.

Additional to the above prediction modes, skip mode and/or direct mode may be applied.

The inter prediction unit 244 may include a motion estimation (ME) unit and a motion compensation (MC) unit (both not shown in FIG. 2). The motion estimation unit may be configured to receive or obtain the picture block 203 (current picture block 203 of the current picture 17) and a decoded picture 231, or at least one or a plurality of previously reconstructed blocks, e.g. reconstructed blocks of one or a plurality of other/different previously decoded pictures 231, for motion estimation. E.g. a video sequence may comprise the current picture and the previously decoded pictures 231, or in other words, the current picture and the previously decoded pictures 231 may be part of or form a sequence of pictures forming a video sequence.

The encoder 20 may, e.g., be configured to select a reference block from a plurality of reference blocks of the same or different pictures of the plurality of other pictures and provide a reference picture (or reference picture index) and/or an offset (spatial offset) between the position (x, y coordinates) of the reference block and the position of the current block as inter prediction parameters to the motion estimation unit. This offset is also called motion vector (MV).

The motion compensation unit is configured to obtain, e.g. receive, an inter prediction parameter and to perform inter prediction based on or using the inter prediction parameter to obtain an inter prediction block 265. Motion compensation, performed by the motion compensation unit, may involve fetching or generating the prediction block based on the motion/block vector determined by motion estimation, possibly performing interpolations to sub-pixel precision. Interpolation filtering may generate additional pixel samples from known pixel samples, thus potentially increasing the number of candidate prediction blocks that may be used to code a picture block. Upon receiving the motion vector for the PU of the current picture block, the motion compensation unit may locate the prediction block to which the motion vector points in one of the reference picture lists.

The motion compensation unit may also generate syntax elements associated with the blocks and video slices for use by video decoder 30 in decoding the picture blocks of the video slice. In addition or as an alternative to slices and respective syntax elements, tile groups and/or tiles and respective syntax elements may be generated or used.

Entropy Coding

The entropy encoding unit 270 is configured to apply, for example, an entropy encoding algorithm or scheme (e.g. a variable length coding (VLC) scheme, an context adaptive VLC scheme (CAVLC), an arithmetic coding scheme, a binarization, a context adaptive binary arithmetic coding (CABAC), syntax-based context-adaptive binary arithmetic coding (SBAC), probability interval partitioning entropy (PIPE) coding or another entropy encoding methodology or technique) or bypass (no compression) on the quantized coefficients 209, inter prediction parameters, intra prediction parameters, loop filter parameters and/or other syntax elements to obtain encoded picture data 21 which can be output via the output 272, e.g. in the form of an encoded bitstream 21, so that, e.g., the video decoder 30 may receive and use the parameters for decoding. The encoded bitstream 21 may be transmitted to video decoder 30, or stored in a memory for later transmission or retrieval by video decoder 30.

Other structural variations of the video encoder 20 can be used to encode the video stream. For example, a non-transform based encoder 20 can quantize the residual signal directly without the transform processing unit 206 for certain blocks or frames. In another implementation, an encoder 20 can have the quantization unit 208 and the inverse quantization unit 210 combined into a single unit.

Decoder and Decoding Method

FIG. 3 shows an example of a video decoder 30 that is configured to implement the techniques of this present application. The video decoder 30 is configured to receive encoded picture data 21 (e.g. encoded bitstream 21), e.g. encoded by encoder 20, to obtain a decoded picture 331. The encoded picture data or bitstream comprises information for decoding the encoded picture data, e.g. data that represents picture blocks of an encoded video slice (and/or tile groups or tiles) and associated syntax elements.

In the example of FIG. 3, the decoder 30 comprises an entropy decoding unit 304, an inverse quantization unit 310, an inverse transform processing unit 312, a reconstruction unit 314 (e.g. a summer 314), a loop filter 320, a decoded picture buffer (DBP) 330, a mode application unit 360, an inter prediction unit 344 and an intra prediction unit 354. Inter prediction unit 344 may be or include a motion compensation unit. Video decoder 30 may, in some examples, perform a decoding pass generally reciprocal to the encoding pass described with respect to video encoder 100 from FIG. 2.

As explained with regard to the encoder 20, the inverse quantization unit 210, the inverse transform processing unit 212, the reconstruction unit 214 the loop filter 220, the decoded picture buffer (DPB) 230, the inter prediction unit 344 and the intra prediction unit 354 are also referred to as forming the “built-in decoder” of video encoder 20. Accordingly, the inverse quantization unit 310 may be identical in function to the inverse quantization unit 110, the inverse transform processing unit 312 may be identical in function to the inverse transform processing unit 212, the reconstruction unit 314 may be identical in function to reconstruction unit 214, the loop filter 320 may be identical in function to the loop filter 220, and the decoded picture buffer 330 may be identical in function to the decoded picture buffer 230. Therefore, the explanations provided for the respective units and functions of the video 20 encoder apply correspondingly to the respective units and functions of the video decoder 30.

Entropy Decoding

The entropy decoding unit 304 is configured to parse the bitstream 21 (or in general encoded picture data 21) and perform, for example, entropy decoding to the encoded picture data 21 to obtain, e.g., quantized coefficients 309 and/or decoded coding parameters (not shown in FIG. 3), e.g. any or all of inter prediction parameters (e.g. reference picture index and motion vector), intra prediction parameter (e.g. intra prediction mode or index), transform parameters, quantization parameters, loop filter parameters, and/or other syntax elements. Entropy decoding unit 304 maybe configured to apply the decoding algorithms or schemes corresponding to the encoding schemes as described with regard to the entropy encoding unit 270 of the encoder 20. Entropy decoding unit 304 may be further configured to provide inter prediction parameters, intra prediction parameter and/or other syntax elements to the mode application unit 360 and other parameters to other units of the decoder 30. Video decoder 30 may receive the syntax elements at the video slice level and/or the video block level. In addition or as an alternative to slices and respective syntax elements, tile groups and/or tiles and respective syntax elements may be received and/or used.

Inverse Quantization

The inverse quantization unit 310 may be configured to receive quantization parameters (QP) (or in general information related to the inverse quantization) and quantized coefficients from the encoded picture data 21 (e.g. by parsing and/or decoding, e.g. by entropy decoding unit 304) and to apply based on the quantization parameters an inverse quantization on the decoded quantized coefficients 309 to obtain dequantized coefficients 311, which may also be referred to as transform coefficients 311. The inverse quantization process may include use of a quantization parameter determined by video encoder 20 for each video block in the video slice (or tile or tile group) to determine a degree of quantization and, likewise, a degree of inverse quantization that should be applied.

Inverse Transform

Inverse transform processing unit 312 may be configured to receive dequantized coefficients 311, also referred to as transform coefficients 311, and to apply a transform to the dequantized coefficients 311 in order to obtain reconstructed residual blocks 213 in the sample domain. The reconstructed residual blocks 213 may also be referred to as transform blocks 313. The transform may be an inverse transform, e.g., an inverse DCT, an inverse DST, an inverse integer transform, or a conceptually similar inverse transform process. The inverse transform processing unit 312 may be further configured to receive transform parameters or corresponding information from the encoded picture data 21 (e.g. by parsing and/or decoding, e.g. by entropy decoding unit 304) to determine the transform to be applied to the dequantized coefficients 311.

Reconstruction

The reconstruction unit 314 (e.g. adder or summer 314) may be configured to add the reconstructed residual block 313, to the prediction block 365 to obtain a reconstructed block 315 in the sample domain, e.g. by adding the sample values of the reconstructed residual block 313 and the sample values of the prediction block 365.

Filtering

The loop filter unit 320 (either in the coding loop or after the coding loop) is configured to filter the reconstructed block 315 to obtain a filtered block 321, e.g. to smooth pixel transitions, or otherwise improve the video quality. The loop filter unit 320 may comprise one or more loop filters such as a de-blocking filter, a sample-adaptive offset (SAO) filter or one or more other filters, e.g. a bilateral filter, an adaptive loop filter (ALF), a sharpening, a smoothing filters or a collaborative filters, or any combination thereof. Although the loop filter unit 320 is shown in FIG. 3 as being an in loop filter, in other configurations, the loop filter unit 320 may be implemented as a post loop filter.

Decoded Picture Buffer

The decoded video blocks 321 of a picture are then stored in decoded picture buffer 330, which stores the decoded pictures 331 as reference pictures for subsequent motion compensation for other pictures and/or for output respectively display.

The decoder 30 is configured to output the decoded picture 311, e.g. via output 312, for presentation or viewing to a user.

Prediction

The inter prediction unit 344 may be identical to the inter prediction unit 244 (in particular to the motion compensation unit) and the intra prediction unit 354 may be identical to the inter prediction unit 254 in function, and performs split or partitioning decisions and prediction based on the partitioning and/or prediction parameters or respective information received from the encoded picture data 21 (e.g. by parsing and/or decoding, e.g. by entropy decoding unit 304). Mode application unit 360 may be configured to perform the prediction (intra or inter prediction) per block based on reconstructed pictures, blocks or respective samples (filtered or unfiltered) to obtain the prediction block 365.

When the video slice is coded as an intra coded (I) slice, intra prediction unit 354 of mode application unit 360 is configured to generate prediction block 365 for a picture block of the current video slice based on a signaled intra prediction mode and data from previously decoded blocks of the current picture. When the video picture is coded as an inter coded (i.e., B, or P) slice, inter prediction unit 344 (e.g. motion compensation unit) of mode application unit 360 is configured to produce prediction blocks 365 for a video block of the current video slice based on the motion vectors and other syntax elements received from entropy decoding unit 304. For inter prediction, the prediction blocks may be produced from one of the reference pictures within one of the reference picture lists. Video decoder 30 may construct the reference frame lists, List 0 and List 1, using default construction techniques based on reference pictures stored in DPB 330. The same or similar may be applied for or by embodiments using tile groups (e.g. video tile groups) and/or tiles (e.g. video tiles) in addition or alternatively to slices (e.g. video slices), e.g. a video may be coded using I, P or B tile groups and/or tiles.

Mode application unit 360 is configured to determine the prediction information for a video block of the current video slice by parsing the motion vectors or related information and other syntax elements, and uses the prediction information to produce the prediction blocks for the current video block being decoded. For example, the mode application unit 360 uses some of the received syntax elements to determine a prediction mode (e.g., intra or inter prediction) used to code the video blocks of the video slice, an inter prediction slice type (e.g., B slice, P slice, or GPB slice), construction information for one or more of the reference picture lists for the slice, motion vectors for each inter encoded video block of the slice, inter prediction status for each inter coded video block of the slice, and other information to decode the video blocks in the current video slice. The same or similar may be applied for or by embodiments using tile groups (e.g. video tile groups) and/or tiles (e.g. video tiles) in addition or alternatively to slices (e.g. video slices), e.g. a video may be coded using I, P or B tile groups and/or tiles.

Embodiments of the video decoder 30 as shown in FIG. 3 may be configured to partition and/or decode the picture by using slices (also referred to as video slices), wherein a picture may be partitioned into or decoded using one or more slices (typically non-overlapping), and each slice may comprise one or more blocks (e.g. CTUs).

Embodiments of the video decoder 30 as shown in FIG. 3 may be configured to partition and/or decode the picture by using tile groups (also referred to as video tile groups) and/or tiles (also referred to as video tiles), wherein a picture may be partitioned into or decoded using one or more tile groups (typically non-overlapping), and each tile group may comprise, e.g. one or more blocks (e.g. CTUs) or one or more tiles, wherein each tile, e.g. may be of rectangular shape and may comprise one or more blocks (e.g. CTUs), e.g. complete or fractional blocks.

Other variations of the video decoder 30 can be used to decode the encoded picture data 21. For example, the decoder 30 can produce the output video stream without the loop filtering unit 320. For example, a non-transform based decoder 30 can inverse-quantize the residual signal directly without the inverse-transform processing unit 312 for certain blocks or frames. In another implementation, the video decoder 30 can have the inverse-quantization unit 310 and the inverse-transform processing unit 312 combined into a single unit.

It should be understood that, in the encoder 20 and the decoder 30, a processing result of a current step may be further processed and then output to the next step. For example, after interpolation filtering, motion vector derivation or loop filtering, a further operation, such as Clip or shift, may be performed on the processing result of the interpolation filtering, motion vector derivation or loop filtering.

It should be noted that further operations may be applied to the derived motion vectors of current block (including but not limit to control point motion vectors of affine mode, sub-block motion vectors in affine, planar, ATMVP modes, temporal motion vectors, and so on). For example, the value of motion vector is constrained to a predefined range according to its representing bit. If the representing bit of motion vector is bitDepth, then the range is −2\hat{ }(bitDepth−1)˜2\hat{ }(bitDepth−1)−1, where “\hat{ }” means exponentiation. For example, if bitDepth is set equal to 16, the range is −32768˜32767; if bitDepth is set equal to 18, the range is −131072˜131071. For example, the value of the derived motion vector (e.g. the MVs of four 4×4 sub-blocks within one 8×8 block) is constrained such that the max difference between integer parts of the four 4×4 sub-block MVs is no more than N pixels, such as no more than 1 pixel. Here provides two methods for constraining the motion vector according to the bitDepth.

Method 1: remove the overflow MSB (most significant bit) by flowing operations

ux=(mvx+2^{bitDepth})%2^{bitDepth} (1)

mvx=(ux>=2^{bitDepth-1})?(ux−2^{bitDepth}):ux (2)

uy=(mvy+2^{bitDepth})%2^{bitDepth} (3)

mvy=(uy>=2^{bitDepth-1})?(uy−2^{bitDepth}):uy (4)
where mvx is a horizontal component of a motion vector of an image block or a sub-block, mvy is a vertical component of a motion vector of an image block or a sub-block, and ux and uy indicates an intermediate value;

For example, if the value of mvx is −32769, after applying formula (1) and (2), the resulting value is 32767. In computer system, decimal numbers are stored as two's complement. The two's complement of −32769 is 1,0111,1111,1111,1111 (17 bits), then the MSB is discarded, so the resulting two's complement is 0111,1111,1111,1111 (decimal number is 32767), which is same as the output by applying formula (1) and (2).

ux=(mvpx+mvdx+2^{bitDepth})%2^{bitDepth} (5)

mvx=(ux>=2^{bitDepth-1})?(ux−2^{bitDepth}):ux (6)

uy=(mvpy+mvdy+2^{bitDepth})%2^{bitDepth} (7)

mvy=(uy>=2^{bitDepth-1})?(uy−2^{bitDepth}):uy (8)

The operations may be applied during the sum of mvp and mvd, as shown in formula (5) to (8).

Method 2: remove the overflow MSB by clipping the value

vx=Clip3(−2^{bitDepth-1},2^{bitDepth-1}−1,vx)

vy=Clip3(−2^{bitDepth-1},2^{bitDepth-1}−1,vy)

where vx is a horizontal component of a motion vector of an image block or a sub-block, vy is a vertical component of a motion vector of an image block or a sub-block; x, y and z respectively correspond to three input value of the MV clipping process, and the definition of function Clip3 is as follow:

$$Clip 3 ( x , y , z ) = \{ \begin{matrix}x & ; & z < x \\ y & ; & z > y \\ z & ; & otherwise\end{matrix}$$

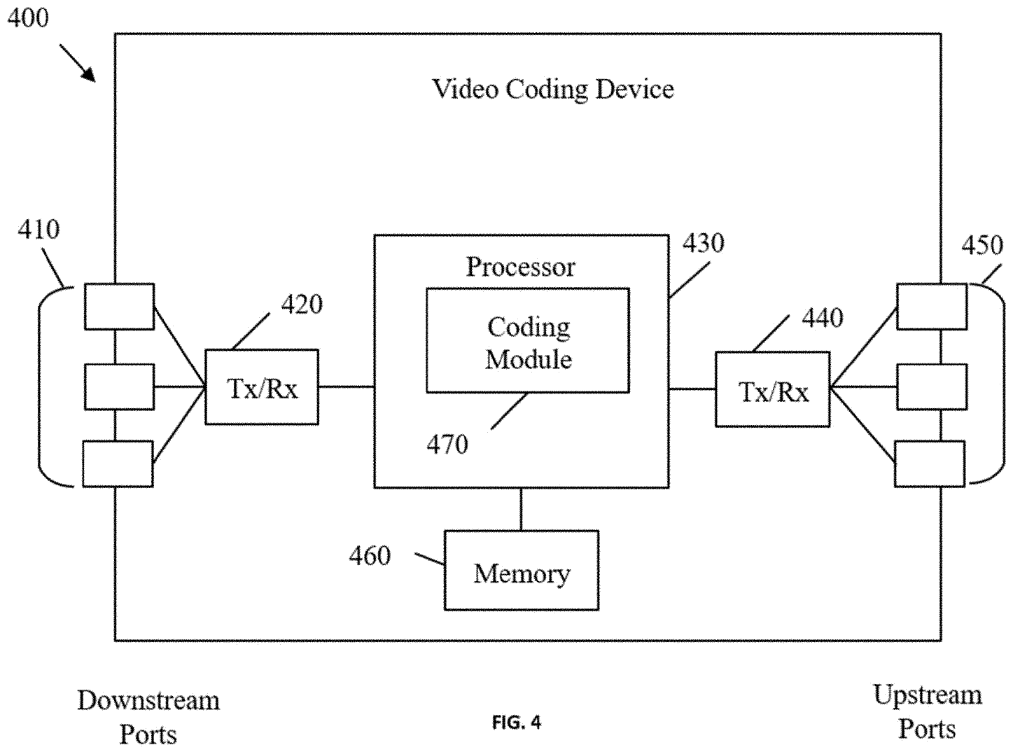

FIG. 4 is a schematic diagram of a video coding device 400 according to an embodiment of the disclosure. The video coding device 400 is suitable for implementing the disclosed embodiments as described herein. In an embodiment, the video coding device 400 may be a decoder such as video decoder 30 of FIG. 1A or an encoder such as video encoder 20 of FIG. 1A.

The video coding device 400 comprises ingress ports 410 (or input ports 410) and receiver units (Rx) 420 for receiving data; a processor, logic unit, or central processing unit (CPU) 430 to process the data; transmitter units (Tx) 440 and egress ports 450 (or output ports 450) for transmitting the data; and a memory 460 for storing the data. The video coding device 400 may also comprise optical-to-electrical (OE) components and electrical-to-optical (EO) components coupled to the ingress ports 410, the receiver units 420, the transmitter units 440, and the egress ports 450 for egress or ingress of optical or electrical signals.

The processor 430 is implemented by hardware and software. The processor 430 may be implemented as one or more CPU chips, cores (e.g., as a multi-core processor), FPGAs, ASICs, and DSPs. The processor 430 is in communication with the ingress ports 410, receiver units 420, transmitter units 440, egress ports 450, and memory 460. The processor 430 comprises a coding module 470. The coding module 470 implements the disclosed embodiments described above. For instance, the coding module 470 implements, processes, prepares, or provides the various coding operations. The inclusion of the coding module 470 therefore provides a substantial improvement to the functionality of the video coding device 400 and effects a transformation of the video coding device 400 to a different state. Alternatively, the coding module 470 is implemented as instructions stored in the memory 460 and executed by the processor 430.

The memory 460 may comprise one or more disks, tape drives, and solid-state drives and may be used as an over-flow data storage device, to store programs when such programs are selected for execution, and to store instructions and data that are read during program execution. The memory 460 may be, for example, volatile and/or non-volatile and may be a read-only memory (ROM), random access memory (RAM), ternary content-addressable memory (TCAM), and/or static random-access memory (SRAM).

FIG. 5 is a simplified block diagram of an apparatus 500 that may be used as either or both of the source device 12 and the destination device 14 from FIG. 1 according to an exemplary embodiment.

A processor 502 in the apparatus 500 can be a central processing unit. Alternatively, the processor 502 can be any other type of device, or multiple devices, capable of manipulating or processing information now-existing or hereafter developed. Although the disclosed implementations can be practiced with a single processor as shown, e.g., the processor 502, advantages in speed and efficiency can be achieved using more than one processor.

A memory 504 in the apparatus 500 can be a read only memory (ROM) device or a random access memory (RAM) device in an implementation. Any other suitable type of storage device can be used as the memory 504. The memory 504 can include code and data 506 that is accessed by the processor 502 using a bus 512. The memory 504 can further include an operating system 508 and application programs 510, the application programs 510 including at least one program that permits the processor 502 to perform the methods described here. For example, the application programs 510 can include applications 1 through N, which further include a video coding application that performs the methods described here.

The apparatus 500 can also include one or more output devices, such as a display 518. The display 518 may be, in one example, a touch sensitive display that combines a display with a touch sensitive element that is operable to sense touch inputs. The display 518 can be coupled to the processor 502 via the bus 512.

Although depicted here as a single bus, the bus 512 of the apparatus 500 can be composed of multiple buses. Further, the secondary storage 514 can be directly coupled to the other components of the apparatus 500 or can be accessed via a network and can comprise a single integrated unit such as a memory card or multiple units such as multiple memory cards. The apparatus 500 can thus be implemented in a wide variety of configurations.

Embodiments of the disclosure relate to intra-prediction coding (encoding and decoding), and in particular to the signalling of intra-prediction modes.

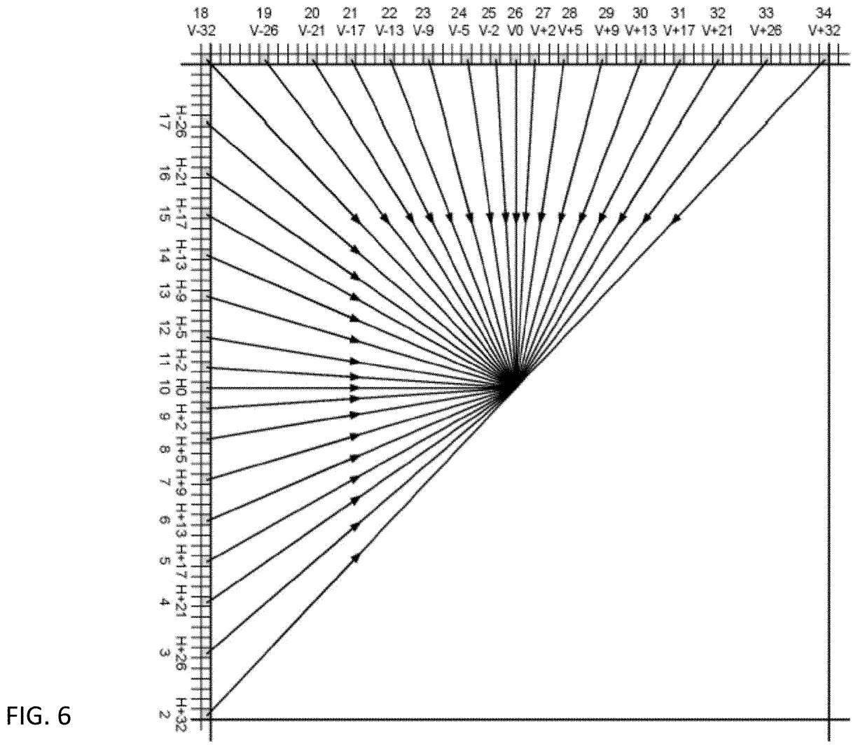

FIG. 6 shows, for example, the angular intra prediction directions and the associated intra-prediction modes respectively their index numbers according to HEVC. Embodiments of the disclosure may be configured to operate according to HEVC. Embodiments of the disclosure may be configured to use, in general, the intra prediction directions and modes as shown in FIG. 6. Index 0 represents a planar mode, index 1 represents a DC mode, and indices 2 to 34 represent 34 angular modes in clock-wise order from bottom left to top right. Each index represents a different mode and direction (in case of the directional intra-prediction modes). The angular intra-prediction modes are also referred to as directional intra-prediction modes, wherein each direction corresponds to an angle.

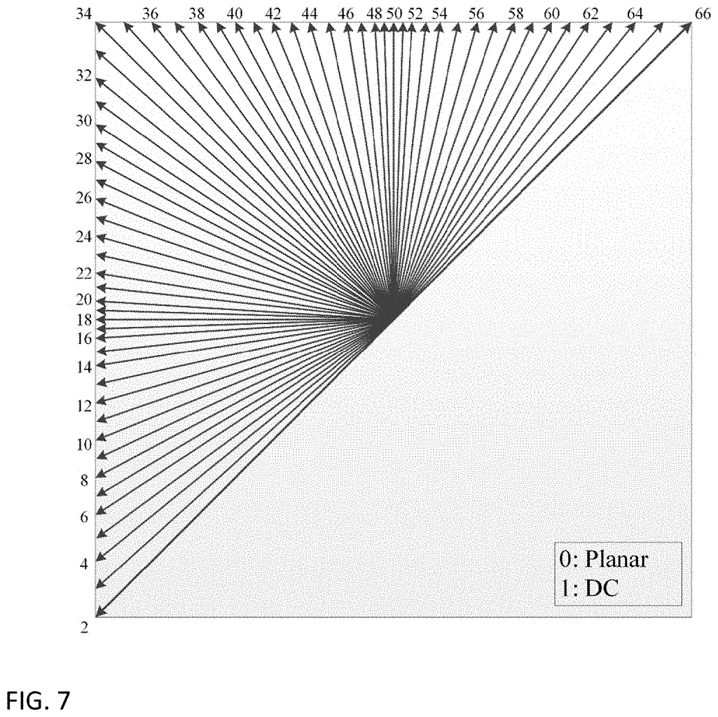

FIG. 7 is a drawing showing angular intra prediction directions and the associated intra-prediction modes respectively their index numbers according to JEM. Embodiments of the disclosure may be configured to operate according to the Joint Exploration Model (JEM). Embodiments of the disclosure may be configured to use, in general, the intra prediction directions and modes as shown in FIG. 7. Index 0 represents a planar mode, index 1 represents a DC mode, and indices 2 to 66 represent 65 angular modes in clock-wise order from bottom left to top right. Each index represents a different mode and direction (in case of the directional intra-prediction modes).

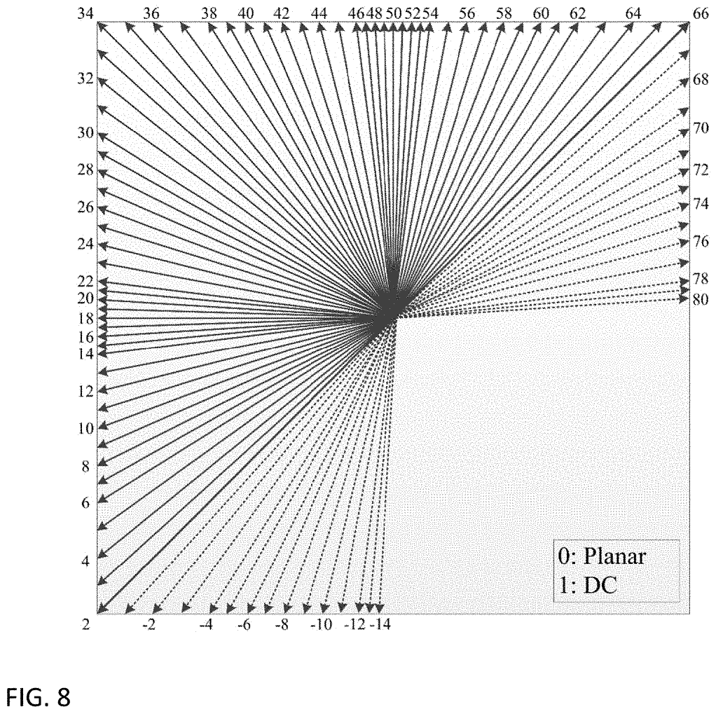

FIG. 8 shows angular intra prediction directions and the associated intra-prediction modes respectively their index numbers according to VTM-3.0 and the VVC specification draft v.3. Embodiments of the disclosure may be configured to operate according to the VTM-3.0 and/or VVC specification draft v.3 or later versions of the VVC. Embodiments of the disclosure may be configured to use, in general, the intra prediction directions and modes as shown in FIG. 8. Index 0 represents a planar mode, index 1 represents a DC mode, and indices 2 to 66 represent 65 angular modes (like in FIG. 7) in clock-wise order from bottom left to top right, and indices −14 to −1 and 67 to 80 represent additional angular modes. Each index represents a different mode and direction (in case of the directional intra-prediction modes).

The angular modes are also be referred to as directional modes. The planar mode and the DC mode do not belong to the group of angular modes.

Embodiments of the disclosure may be configured to use other intra prediction modes than shown in FIGS. 6 to 8 and may be configured to operate according to other standards or CODECS than HEVC, JEM or VVC.

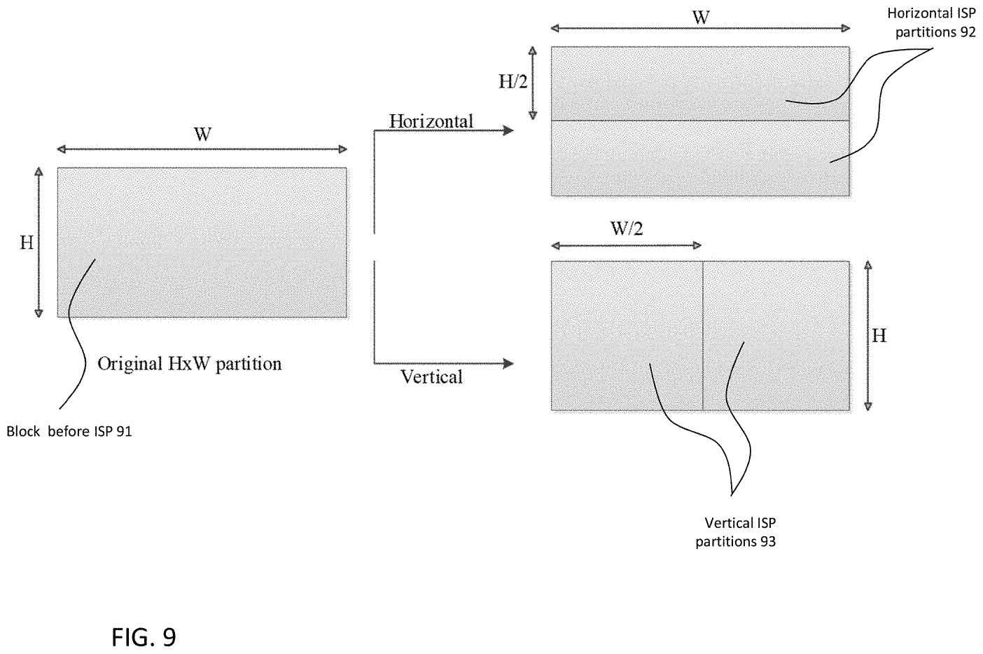

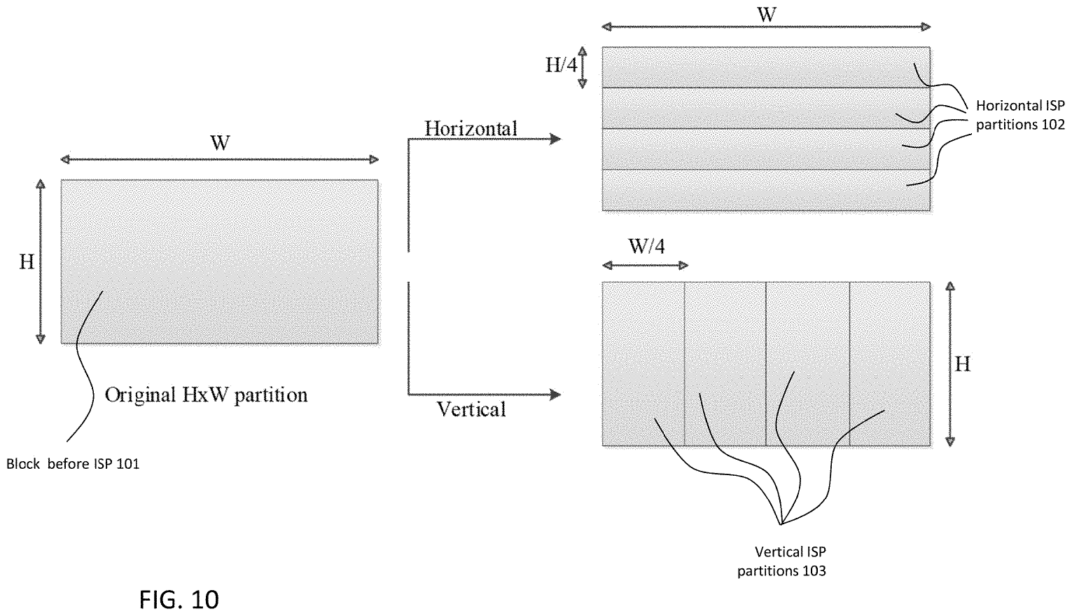

Embodiments of the disclosure may implement an Intra Sub-Partitions (ISP) tool that, for example, divides luma intra-predicted blocks vertically or horizontally into 2 or 4 sub-partitions depending on the block size dimensions, as shown in FIGS. 9 and 10.

FIG. 9 shows a partition or block 91 with a height H (e.g. in samples) and a width W (e.g. in samples). As shown in FIG. 9, the block 91 is split either horizontally or vertically resulting in two equally sized horizontal partitions 92 or two vertical partitions 93. Embodiments perform the selection between horizontal and vertical split directions based on the signaling, e.g. received as part of encoded picture data 21, e.g. as part of a bitstream. Depending on the size of the block, the number of resulting equally sized partitions is either 2 or 4. Exemplary size conditions to determine the number of resulting partitions are shown in Table 1.

TABLE 1
Number of sub-partitions depending on the block size

| Block Size | Number of Sub-Partitions |
|---|---|
| 4 × 4 | Not divided |
| 4 × 8 and 8 × 4 | 2 |
| All other cases | 4 |

According to Table 1 and FIG. 10, blocks 101 larger than 4×8 and 8×4 are split to 4 equally sized horizontal 102 or vertical 103 partitions.

Resulting partitions are intra-predicted using the intra prediction mode that is signaled once per block 91. Steps 204, 206, 208, 210 and 212 of FIG. 2 and steps 310 and 312 of FIG. 3 are, for example, performed for each of the partitions 902, 903, 102, 103 shown in FIG. 9 and FIG. 10. Noticeably, all sub-partitions fulfill the condition of having at least 16 samples. The partitions or sub-partitions 92, 93, 102 and 103, may also be referred to as blocks or sub-blocks.

At the decoder, for each of these sub-partitions, a residual signal is generated by entropy decoding the coefficients received from a bitstream or in general encoded picture data 21 and then inverse quantizing and inverse transforming them (e.g. 310 and 312 of FIG. 3). Then, the partition or sub-partition is intra predicted (e.g. 354 of FIG. 3) and finally the corresponding reconstructed samples (e.g. 315 of FIG. 3) are obtained by adding the residual signal (e.g. 313 of FIG. 3) to the prediction signal (e.g. 365 of FIG. 3). Thus, the reconstructed values of each sub-partition are available to generate the prediction of the next one, and the process is repeated to reconstruct and decode step-by-step all partitions respectively sub-partitions. All sub-partitions, e.g. 92, 94, 102, 103, obtained by the ISP tool share the same intra mode.

Additional restriction can be applied to the result of the ISP, e.g. the resulting partitions must have a width of at least 4 samples. This implies, for example, that 4×N blocks can no longer be divided vertically (and therefore no split type parameter signaling is required) and 8×N blocks are divided in 2 sub-partitions if the split is vertical (instead of 4). The corresponding applies for N×4 and N×8 blocks for horizontal splits when using ISP.

Embodiments of the disclosure may implement multiple reference line (MRL) intra-prediction. Conventional intra-prediction typically uses only the single sample row adjacent to the current block. MRL allows to use further sample rows that are not directly adjacent to the current block. An MRL index can be used to define the distance between an intra-coded block and reference samples used to predict the intra-coded block. The MRL index can take any integer non-negative value. Embodiments may use reference lines with distances of 0, 1, and 3 sample rows and use MRL index values of 0, 1, and 2 as corresponding index values, like in VVC. The MRL index value 0 indicates to use the single sample row adjacent to the current block, or in other words to not use MRL. Further embodiments may use other reference rows and other mapping of the MRL indices to the specific rows.

Embodiments of the disclosure may be configured to apply an intra prediction signaling such that ISP is disabled when the multiple reference line (MRL) index, for example also referred to as intra_luma_ref_idx, is non-zero, in the above example (or in general, indicates to apply MRL). Embodiments of the disclosure may be configured to infer the ISP index to be zero (or any other predetermined value indicating that ISP is not used), when the signaled MRL index is non-zero (or in general indicates to use MRL).

Embodiments of the disclosure, e.g. decoder embodiments, may be configured to assume for a block partitioned using ISP that at least one of the sub-partitions has a non-zero Coded Block Flag (CBF). For this reason, if n is the number of sub-partitions and the first n−1 sub-partitions have produced a zero CBF, then the CBF of the n-th sub-partition will be inferred to be 1. Therefore, it is not necessary to transmit and decode it.

Embodiments of the disclosure, e.g. encoder embodiments, may be configured to test the ISP algorithm only with intra modes that are part of the Most Probable Mode (MPM) list. Therefore, embodiments can be configured to infer whether MPM-based intra-prediction mode signaling is used (e.g. specifically whether an intra-prediction mode or index is comprised in the MPM list), or not based on whether ISP is used or not. The MPM flag may also be referred to as intra_luma_mpm_flag, like in VVC. Embodiments, where an MPM flag value of one indicates that MPM-based intra-prediction mode signaling is used (e.g. specifically that an intra-prediction mode of a current block or partition is comprised in the MPM list), can be configured, if a block uses ISP, to infer a value of the MPM flag, e.g. intra_luma_mpm_flag), to be one. In embodiments, for example, MPM-based intra-prediction mode signaling is used, when intra_luma_mpm_flag equals 1. Otherwise, the intra-prediction mode signaling is not MPM-based. If ISP is used for a certain block, embodiments may also be configured to modify the MPM list to exclude the DC mode and to prioritize horizontal intra modes for the ISP horizontal split and vertical intra modes for the vertical one.

Embodiments may be configured such that when MRL intra prediction is applied to a block (e.g. intra_luma_ref_idx is non-zero), intra prediction mode always belongs to the MPM list. In this case, intra_luma_mpm_flag is set to 1 and is not signaled in the bitstream.

Embodiments may implement MRL such that MRL (i.e. the use of non-adjacent reference samples, i.e. located at some distance from a block to be predicted) is applied if and only if the selected intra prediction mode is directional (angular).

To harmonize the design of the MPM list for conventional intra-prediction cases (when only adjacent reference samples are used for generating an intra predictor, i.e. intra_luma_ref_idx equals 0) and MRL (i.e. intra_luma_ref_idx is greater than 0), the following pseudo-syntax was proposed in JVET-M0528:

```
if (!intra_luma_ref_idx)
  intra_luma_angular_mode_flag
  if (!intra_luma_angular_mode_flag)
    intra_luma_planar_flag // Planar if true, DC otherwise
if (intra_luma_ref_idx ∥ intra_luma_angular_mode_flag)
  if (intra_luma_ref_idx)
    intra_luma_mpm_flag=1
  else
    intra_luma_mpm_flag
  if (intra_luma_mpm_flag)
    intra_luma_mpm_idx
  else
    intra_luma_mpm_remainder
```

In this case, intra prediction modes are classified into 2 groups:
Angular modes (i.e. intra_luma_angular_mode_flag equals 1),
Other modes (i.e. Planar and DC modes for that intra_luma_angular_mode_flag equals 0).

To distinguish between the two non-angular modes (Planar mode and DC mode), intra_luma_planar_flag is used. A zero value corresponds or indicates DC mode, a value of one corresponds to Planar mode.

The pseudo-syntax above assumes that MRL index (intra_luma_ref_idx) is parsed first. When the value of intra_luma_ref_idx is non-zero (i.e. non-adjacent reference samples are used to predict a block), intra_luma_angular_mode_flag is inferred to be 1. Otherwise, intra_luma_angular_mode_flag should be parsed. If, at least, intra_luma_ref_idx or intra_luma_angular_mode_flag have non-zero values, intra_luma_mpm_flag should be inferred to be 1 (when intra_luma_ref_idx is non-zero) or parsed from a bit-stream. When intra_luma_mpm_flag is non-zero, MPM index (intra_luma_mpm_idx) should be parsed. Otherwise, a set of bins that code remained intra-prediction modes (i.e. modes that do not belong to MPM list) should be parsed.

For multi-hypothesis intra coding, also known as Combined Intra/Inter Prediction (CIIP), the only angular modes allowed are vertical and horizontal. Hence, a single flag is signaled to distinguish between the two angular modes (no list construction is needed) as mentioned in JVET-M0528. The modifications proposed there have the syntax described below.

| | Des- |
|---|---|
| coding_unit( x0, y0, cbWidth, cbHeight, treeType ) { | criptor |
| if( slice_type != I ) { | |
| cu_skip_flag[ x0 ][ y0 ] | ae(v) |
| if( cu_skip_flag[ x0 ][ y0 ] == 0 ) | |
| pred_mode_flag | ae(v) |
| } | |
| if( CuPredMode[ x0 ][ y0 ] == MODE_INTRA ) { | |
| ... | |
| if( pcm_flag[ x0 ][ y0 ] ) { | |
| ... | |
| } else { | |
| if( treeType == SINGLE_TREE \|\| treeType == | |
| DUAL_TREE_LUMA ) { | |
| if( ( y0 % CtbSizeY ) > 0 ) | |
| intra_luma_ref_idx[ x0 ][ y0 ] | ae(v) |
| if (intra_luma_ref_idx[ x0 ][ y0 ] == 0) | |
| intra_luma_angular_mode_flag[ x0 ][ y0 ] | ae(v) |
| if (intra_luma_angular_mode_ | |
| flag[ x0 ][ y0 ] == 0) | |
| intra_luma_planar_flag[ x0 ][ y0 ] | ae(v) |
| if (intra_luma_ref_idx[ x0 ][ y0 ] != 0\|\| | |
| intra_luma_angular_mode_flag[ x0 ][ y0 ] != 0) { | |
| intra_luma_mpm_flag[ x0 ][ y0 ] | ae(v) |
| if( intra_luma_mpm_flag[ x0 ][ y0 ] ) | |
| intra_luma_mpm_idx[ x0 ][ y0 ] | ae(v) |
| else | |
| intra_luma_mpm_remainder[ x0 ][ y0 ] | ae(v) |
| } | |
| } | |
| if( treeType == SINGLE_TREE \|\| treeType == | |
| DUAL_TREE_CHROMA ) | |
| intra_chroma_pred_mode[ x0 ][ y0 ] | ae(v) |
| } | |
| ... | |
| if( mmvd_flag[ x0 ][ y0 ] == 0 && | |
| merge_subblock_flag[ x0 ][ y0 ] == 0 && | |
| ( cbWidth * cbHeight ) >= 64 && cbWidth < 128 && | |
| cbHeight < 128 ) { | |
| mh_intra _flag[ x0 ][ y0 ] | ae(v) |
| if( mh_intra_flag[ x0 ][ y0 ] ) { | |
| intra_luma_angular_mode _flag[ x0 ][ y0 ] | ae(v) |
| if( intra_angular_mode_flag[ x0 ][ y0 ] ) | |
| mh_intra_luma_vert_flag[ x0 ][ y0 ] | ae(v) |
| else | |
| intra_luma_planar_flag[ x0 ][ y0 ] | ae(v) |
| } | |
| } | |

intra_luma_angular_mode_flag[x0][y0] equal to 1 specifies that the intra prediction mode for luma samples is angular. intra_luma_angular_mode_flag[x0][y0] equal to 0 specifies that the intra prediction mode for luma samples is not angular. When intra_luma_angular_mode_flag[x0][y0] is not present it is inferred to be equal to 1. intra_luma_planar_flag[x0][y0] equal to 1 specifies that the intra prediction mode for luma samples is PLANAR. intra_luma_planar_flag[x0][y0] equal to 0 specifies that the intra prediction mode for luma samples is DC. When intra_luma_planar_flag[x0][y0] is not present it is inferred to be equal to 1.

When mh_intra_flag[x0][y0] is equal to 0, the syntax elements intra_luma_mpm_flag[x0][y0], intra_luma_mpm_idx[x0][y0] and intra_luma_mpm_remainder[x0][y0] specify the angular intra prediction mode for luma samples. The array indices x0, y0 specify the location (x0, y0) of the top-left luma sample of the considered coding block relative to the top-left luma sample of the picture. When intra_luma_angular_mode_flag[x0][y0] is equal to 1 and intra_luma_mpm_flag[x0][y0] is equal to 1, the intra prediction mode is inferred from a neighbouring intra-predicted coding unit according to clause 8.2.2.

mh_intra_luma_vert_flag[x0][y0] equal to 1 specifies that the intra prediction mode for luma samples is INTRA_ANGULAR50. mh_intra_luma_vert_flag[x0][y0] equal to 0 specifies that the intra prediction mode for luma samples is INTRA_ANGULAR18. When intra_luma_vert_flag[x0][y0] is not present it is inferred to be equal to 0.

When mh_intra_flag[x0][y0] is equal to 1, the syntax elements intra_luma_angular_mode_flag[x0][y0], mh_intra_luma_vert_flag[x0][y0], and intra_luma_planar_flag[x0][y0] specify the intra prediction mode for luma samples used in combined inter-picture merge and intra-picture prediction. The array indices x0, y0 specify the location (x0, y0) of the top-left luma sample of the considered coding block relative to the top-left luma sample of the picture. The intra prediction mode IntraPredModeY is derived as follows:

```
if( intra_angular_mode_flag[ x0 ][ y0 ] != 0 ) {
  IntraPredModeY = ( mh_intra_luma_vert_flag[ x0 ][ y0 ] )? INTRA_ANGULAR50 :
INTRA_ANGULAR18
} else {
  IntraPredModeY = ( intra_luma_planar_flag[ x0 ][ y0 ] )? INTRA_PLANAR :
INTRA_DC
}
```

8.2.2 Derivation Process for Luma Intra Prediction Mode
Input to this process are:
   a luma location (xCb, yCb) specifying the top-left sample of the current luma coding block relative to the top-left luma sample of the current picture,
   a variable cbWidth specifying the width of the current coding block in luma samples,
   a variable cbHeight specifying the height of the current coding block in luma samples.
In this process, the luma intra prediction mode IntraPredModeY[xCb][yCb] is derived.
Table 8-1 specifies the value for the intra prediction mode IntraPredModeY[xCb][yCb] and the associated names.

TABLE 8-1
Specification of intra prediction mode and associated names

| Intra prediction | |
|---|---|
| mode | Associated name |
| 0 | INTRA_PLANAR |
| 1 | INTRA_DC |
| 2 . . . 66 | INTRA_ANGULAR2..INTRA_ANGULAR66 |
| 81 . . . 83 | INTRA_LT_CCLM, INTRA_L_CCLM, |
| | INTRA_T_CCLM |

NOTE
−: The intra prediction modes INTRA_LT_CCLM, INTRA_L_CCLM and INTRA_T_CCLM are only applicable to chroma components.

IntraPredModeY[xCb][yCb] is derived by the following ordered steps:
1. The neighbouring locations (xNbA, yNbA) and (xNbB, yNbB) are set equal to (xCb−1, yCb+cbHeight−1) and (xCb+cbWidth−1, yCb−1), respectively.
2. For X being replaced by either A or B, the variables candIntraPredModeX are derived as follows:
   The availability derivation process for a block as specified in clause 6.4.X [Ed. (BB): Neighbouring blocks availability checking process tbd] is invoked with the location (xCurr, yCurr) set equal to (xCb, yCb) and the neighbouring location (xNbY, yNbY) set equal to (xNbX, yNbX) as inputs, and the output is assigned to availableX.
   The candidate intra prediction mode candIntraPredModeX is derived as follows:
      If one or more of the following conditions are true, candIntraPredModeX is set equal to INTRA_PLANAR.
         The variable availableX is equal to FALSE.
         CuPredMode[xNbX][yNbX] is not equal to MODE_INTRA and mh_intra_flag[xNbX][yNbX] is not equal to 1.
         pcm_flag[xNbX][yNbX] is equal to 1.
         X is equal to B and yCb−1 is less than ((yCb>>Ctb Log 2SizeY)<<Ctb Log 2SizeY).
      Otherwise, candIntraPredModeX is set equal to IntraPredModeY[xNbX][yNbX].
3. The candModeList[x] with x=0 . . . 5 is derived as follows:
   If candIntraPredModeB is equal to candIntraPredModeA and candIntraPredModeA is greater than INTRA_DC, candModeList[x] with x=0 . . . 5 is derived as follows:

candModeList[0]=candIntraPredModeA (8-10)

candModeList[1]=2+((candIntraPredModeA+61)%64) (8-11)

candModeList[2]=2+((candIntraPredModeA−1)%64) (8-12)

candModeList[3]=2+((candIntraPredModeA+60)%64) (8-13)

candModeList[4]=2+(candIntraPredModeA%64) (8-14)

candModeList[5]=2+((candIntraPredModeA+59)%64) (8-15)
Otherwise if candIntraPredModeB is not equal to candIntraPredModeA and candIntraPredModeA or candIntraPredModeB is greater than INTRA_DC, the following applies:
   The variables minAB and maxAB are derived as follows:

minAB=Min(candIntraPredModeA,candIntraPredModeB) (8-16)

maxAB=Max(candIntraPredModeA,candIntraPredModeB) (8-17)
If candIntraPredModeA and candIntraPredModeB are both greater than INTRA_DC, candModeList[x] with x=0 . . . 5 is derived as follows:

candModeList[0]=candIntraPredModeA (8-18)

candModeList[1]=candIntraPredModeB (8-19)
If maxAB−minAB is equal to 1, the following applies:

candModeList[2]=2+((minAB+61)%64) (8-26)

candModeList[3]=2+((maxAB−1)%64) (8-27)

candModeList[4]=2+((minAB+60)%64) (8-28)

candModeList[5]=2+(maxAB%64) (8-29)
Otherwise if maxAB−minAB is equal to 2, the following applies:

candModeList[2]=2+((minAB−1)%64) (8-30)

candModeList[3]=2+((minAB+61)%64) (8-31)

candModeList[4]=2+((maxAB−1)%64) (8-32)

candModeList[5]=2+((minAB+60)%64) (8-33)
Otherwise if maxAB−minAB is greater than 61, the following applies:

candModeList[2]=2+((minAB−1)%64) (8-34)

candModeList[3]=2+((maxAB+61)%64) (8-35)

candModeList[4]=2+(minAB%64) (8-36)

candModeList[5]=2+((maxAB+60)%64) (8-37)
Otherwise, the following applies:

candModeList[2]=2+((minAB+61)%64) (8-38)

candModeList[3]=2+((minAB−1)%64) (8-39)

candModeList[4]=2+((maxAB+61)%64) (8-40)

candModeList[5]=2+((maxAB−1)%64) (8-41)
Otherwise (candIntraPredModeA or candIntraPredModeB is greater than INTRA_DC), candModeList[x] with x=0 . . . 5 is derived as follows:

candModeList[0]=maxAB (8-48)

candModeList[1]=2+((maxAB+61)%64) (8-49)

candModeList[2]=2+((maxAB−1)%64) (8-50)

candModeList[3]=2+((maxAB+60)%64) (8-51)

candModeList[4]=2+(maxAB%64) (8-52)

candModeList[5]=2+((maxAB+59)%64) (8-53)
Otherwise, the following applies:

candModeList[0]=INTRA_ANGULAR50 (8-60)

candModeList[1]=INTRA_ANGULAR18 (8-61)

candModeList[2]=INTRA_ANGULAR2 (8-62)

candModeList[3]=INTRA_ANGULAR34 (8-63)

candModeList[4]=INTRA_ANGULAR66 (8-64)

candModeList[5]=INTRA_ANGULAR26 (8-65)
4. IntraPredModeY[xCb][yCb] is derived by applying the following procedure:
   If intra_luma_mpm_flag[xCb][yCb] is equal to 1, the IntraPredModeY[xCb][yCb] is set equal to candModeList[intra_luma_mpm_idx[xCb][yCb] ].
   Otherwise, IntraPredModeY[xCb][yCb] is derived by applying the following ordered steps:
      1. When candModeList[i] is greater than candModeList[j] for i=0 . . . 4 and for each i, j=(i+1) . . . 5, both values are swapped as follows:

(candModeList[i],candModeList[j])=Swap(candModeList[i],candModeList[j]) (8-66)
2. IntraPredModeY[xCb][yCb] is derived by the following ordered steps:
   i. IntraPredModeY[xCb][yCb] is set equal to (intra_luma_mpm_remainder[xCb][yCb]+2).
   ii. For i equal to 0 to 5, inclusive, when IntraPredModeY[xCb][yCb] is greater than or equal to candModeList[i], the value of IntraPredModeY[xCb][yCb] is incremented by one.

The variable IntraPredModeY[x][y] with x=xCb . . . xCb+cbWidth−1 and y=yCb . . . yCb+cbHeight−1 is set to be equal to IntraPredModeY[xCb][yCb].

TABLE 9-4
Syntax elements and associated binarizations

| Syntax | | Binarization | |
|---|---|---|---|
| structure | Syntax element | Process | Input parameters |
| coding_unit( ) | cu_skip_flag[ ][ ] | FL | cMax = 1 |
| | pred_mode_flag | FL | cMax = 1 |
| | pcm_flag[ ][ ] | FL | cMax = 1 |
| | intra_luma_ref_idx[ ][ ] | TR | cMax = 2, cRiceParam = 0 |
| | intra_luma_angular_mode_flag[ ][ ] | FL | cMax = 1 |
| | intra_luma_planar_flag[ ][ ] | FL | cMax = 1 |
| | intra_luma_mpm_flag[ ][ ] | FL | cMax = 1 |
| | intra_luma_mpm_idx[ ][ ] | TR | cMax = 5, cRiceParam = 0 |
| | intra_luma_mpm_remainder[ ][ ] | TB | cMax = [symbol] 58 |
| | intra_chroma_pred_mode[ ][ ] | 9.5.3.7 | — |
| | merge_flag[ ][ ] | FL | cMax = 1 |
| | inter_pred_idc[ x0 ][ y0 ] | 9.5.3.8 | cbWidth, cbHeight |
| merge_data( ) | mmvd_flag[ ][ ] | FL | cMax = 1 |
| | mmvd_merge_flag[ ][ ] | FL | cMax = 1 |
| | mmvd_distance_idx[ ][ ] | TR | cMax = 7, cRiceParam = 0 |
| | mmvd_direction_idx[ ][ ] | FL | cMax = 3 |
| | mh_intra_flag[ ][ ] | FL | cMax = 1 |
| | merge_subblock_flag[ ][ ] | FL | cMax = 1 |
| | merge_subblock_idx[ ][ ] | TR | cMax = MaxNumSubblockMergeCand − 1, |
| | | | cRiceParam = 0 |

TABLE 9-10
Assignment of ctxInc to syntax elements with context coded bins

| | binIdx | | | | | |
|---|---|---|---|---|---|---|
| Syntax element | 0 | 1 | 2 | 3 | 4 | >=5 |
| end_of_slice_flag | terminate | na | na | na | na | na |
| alf_ctb_flag[ ][ ][ ] | 0..8 | na | na | na | na | na |
| | (clause | | | | | |
| | 9.5.4.2.2) | | | | | |
| sao_merge_left_flag | 0 | na | na | na | na | na |
| sao_merge_up_flag | 0 | na | na | na | na | na |
| sao_type_idx_luma | 0 | bypass | na | na | na | na |
| sao_type_idx_chroma | 0 | bypass | na | na | na | na |
| .. | .. | .. | .. | .. | .. | .. |
| pcm_flag[ ][ ] | terminate | na | na | na | na | na |
| intra_luma_ref_idx[ ][ ] | 0 | 1 | 2 | na | na | na |
| intra_luma_angular_ | When | na | na | na | na | na |
| mode_flag[ ][ ] | mh_intra_ | | | | | |
| | flag[ ][ ] is | | | | | |
| | equal to 0, | | | | | |
| | ctxInc is | | | | | |
| | between 0..4 | | | | | |
| | and derived | | | | | |
| | per clause | | | | | |
| | a.b.c.d.e. | | | | | |
| | When | | | | | |
| | mh_intra_ | | | | | |
| | flag[ ][ ] is | | | | | |
| | equal to 1, | | | | | |
| | ctxInc is | | | | | |
| | (cbWidth > | | | | | |
| | 2*cbHeight ∥ | | | | | |
| | cbHeight > | | | | | |
| | 2*cbWidth) | | | | | |
| | ? 5 : 6 | | | | | |
| intra_luma_planar_flag[ ][ ] | mh_intra_ | na | na | na | na | na |
| | flag[ ][ ] ? 0 : 1 | | | | | |
| intra_luma_mpm_flag[ ][ ] | 0 | na | na | na | na | na |
| intra_luma_mpm_idx[ ][ ] | Bypass | bypass | bypass | bypass | bypass | na |
| intra_luma_mpm_ | Bypass | bypass | bypass | bypass | bypass | bypass |
| remainder[ ][ ] | | | | | | |
| .. | .. | .. | .. | .. | .. | .. |
| merge_idx[ ][ ] | 0 | bypass | bypass | bypass | bypass | na |
| mh_intra_flag[ ][ ] | 0 | na | na | na | na | na |
| mh_intra_luma_vert_flag | bypass | na | na | na | na | na |
| [ ][ ] | | | | | | |
| . . . | . . . | . . . | . . . | . . . | . . . | . . . |

An alternative MPM syntax is presented in JVET-M0210. As stated in JVET-M1023, the modifications proposed in JVET-M0210 are motivated by the following problems in the VTM-3.0 software and the VVC working draft of version 3. In VTM-3.0, for the intra prediction coding process, intra_luma_ref_idx is always signaled, even for Planar and DC which are excluded from multiple reference line intra prediction. Also two different MPM list derivation schemes (with and without Planar and DC modes) are applied.

JVET-M0210 proposes an Intra prediction information coding method, in which a syntax element intra_luma_non_ang_flag, is signaled at first for intra blocks to determine whether IntraMode is angular or non angular. For non_angular mode, intra_luma_planar_flag is signaled to indicate whether IntraMode is planar or DC. For angular mode, syntax elements intra_luma_ref_idx, intra_luma_mpm_flag, intra_luma_mpm_idx and intra_luma_mpm_remainder are signaled as in VTM-3.0. The MPM list is used only in the case of angular modes. The following pseudo-syntax covers the modifications proposed in JVET-M0210:

```
parse intra_luma_non_ang_flag
if(intra_luma_non_ang_flag == 1)
  parse intra_luma_planar_flag
  IntraMode = (intra_luma_planar_flag == 1) ? Planar: DC
else
  parse intra_luma_mpm_flag
  if (intra_luma_mpm_flag)
    parse intra_luma_mpm_idx, intra_luma_ref_idx
    IntraMode = mpm1[intra_luma_mpm_idx] // MPM without Planar&DC
  else
    Parse intra_luma_mpm_remainder
    IntraMode = intra_luma_mpm_remainder
```

The pseudo-syntax shown above can be explained as follows.

The first step consists in determining whether an intra prediction mode is a directional mode. This is performed by parsing a flag called “intra_luma_non_ang_flag” from the bitstream. When the value of the flag is “1”, intra prediction mode is set either to DC or PLANAR. Determination between these two modes is performed by parsing an additional flag called “intra_luma_planar_flag”. When this flag is equal to “1”, intra prediction mode “IntraMode” is set equal to PLANAR. Otherwise, the intra prediction mode “IntraMode” is set equal to DC one.

When the value of “intra_luma_non_ang_flag” is “0”, intra prediction mode “IntraMode” is directional. The value of intra prediction mode “IntraMode” is derived either from the list of most-probable modes (MPM list) or from the remainder of this list using either intra_luma_mpm_idx or intra_luma_mpm_remainder values. The decision between these two syntax elements is signalled to the decoder using “intra_luma_mpm_flag” syntax element. When “intra_luma_mpm_flag” is “1”, intra_luma_mpm_idx is signalled in the bitstream, otherwise intra_luma_mpm_remainder is signalled.

MRL index (“intra_luma_ref_idx”) is signaled only in the case when MPM list usage is enabled (i.e., “intra_luma_mpm_flag” is “1”).

The syntax changes as compared with the VVC working draft of version 3 are illustrated below:

7.3.4.6 Coding Unit Syntax

| | Des- |
|---|---|
| coding_unit( x0, y0, cbWidth, cbHeight, treeType ) { | criptor |
| ... | |
| if( CuPredMode[ x0 ][ y0 ] == MODE_INTRA ) { | |
| if( pcm_enabled_flag && | |
| cbWidth >= MinIpcmCbSizeY && cbWidth | |
| <= MaxIpcmCbSizeY && | |
| cbHeight >= MinIpcmCbSizeY && cbHeight <= | |
| MaxIpcmCbSizeY ) | |
| pcm_flag[ x0 ][ y0 ] | |
| if( pcm_flag[ x0 ][ y0 ] ) { | |
| while( !byte_aligned( ) ) | |
| pcm_alignment_zero_bit | |
| pcm_sample( cbWidth, cbHeight, treeType) | |
| } else { | |
| if( treeType == SINGLE_TREE \|\| treeType == | |
| DUAL_TREE_LUMA ) { | |
| intra_luma_non_ang_flag[x0][y0] | ae(v) |
| if( intra_luma_non_ang_flag == 0 ) { | |
| intra_luma_mpm_flag[ x0 ][ y0 ] | ae(v) |
| if( intra_luma_mpm_flag[ x0 ][ y0 ] ) { | |
| intra_luma_mpm_idx[ x0 ][ y0 ] | ae(v) |
| if( ( y0 % CtbSizeY ) > 0 ) | |
| intra_luma_ref_idx[ x0 ][ y0 ] | ae(v) |
| } else | |
| intra_luma_mpm_remainder[ x0 ][ y0 ] | ae(v) |
| } else { | |
| intra_luma_planar_flag[ x0 ][ y0 ] | ae(v) |
| } | |
| } | |
| if( treeType == SINGLE_TREE \|\| treeType == | |
| DUAL_TREE_CHROMA ) | |
| intra_chroma_pred_mode[ x0 ][ y0 ] | ae(v) |
| } | |
| } else { /* MODE_INTER */ | |
| ... | |
| } | |
| ... | |
| } | |

7.4.5.6 Coding Unit Semantics

pcm_flag[x0][y0] equal to 1 specifies that the pcm_sample( ) syntax structure is present and the transform tree( ) syntax structure is not present in the coding unit including the luma coding block at the location (x0, y0). pcm_flag[x0][y0] equal to 0 specifies that pcm_sample( ) syntax structure is not present. When pcm_flag[x0][y0] is not present, it is inferred to be equal to 0.

The value of pcm_flag[x0+i][y0+j] with i=1 . . . cbWidth−1, j=1 . . . cbHeight−1 is inferred to be equal to pcm_flag[x0][y0].

pcm_alignment_zero_bit is a bit equal to 0.

intra_luma_non_ang_flag[x0][y0] equal to 1 specifies that the intra prediction mode for luma samples is not angular. intra_luma_non_ang_flag[x0][y0] equal to 0 specifies that the intra prediction mode for luma samples is angular. When intra_luma_non_ang_flag[x0][y0] is not present it is inferred to be equal to 1.

When intra_luma_non_ang_flag[x0][y0] is equal to 1, intra_luma_planar_flag[x0][y0] specify intra prediction mode for luma samples is PLANAR or DC. intra_luma_planar_flag[x0][y0] equal to 1 specifies that the intra prediction mode for luma samples is PLANAR. intra_luma_planar_flag[x0][y0] equal to 0 specifies that the intra prediction mode for luma samples is DC. When intra_luma_planar_flag[x0][y0] is not present it is inferred to be equal to 1.

When intra_luma_non_ang_flag[x0][y0] is equal to 0 and intra_luma_mpm_flag[x0][y0] is equal to 1, intra_luma_ref_idx[x0][y0] specifies the intra prediction reference line index IntraLumaRefLineIdx[x][y] for x=x0 . . . x0+cbWidth−1 and y=y0 . . . y0+cbHeight−1 as specified in Table 7-6.

TABLE 7-6
Specification of IntraLumaRefLineIdx[ x ][ y ] based on
intra_luma_ref_idx[ x0 ][ y0 ].

| | IntraLumaRefLineIdx[ x ][ y ] |
|---|---|
| | x = x0 . . . x0 + cbWidth − 1 |
| intra_luma_ref_idx[ x0 ][ y0 ] | y = y0 . . . y0 + cbHeight − 1 |
| 0 | 0 |
| 1 | 1 |
| 2 | 3 |

When intra_luma_non_ang_flag[x0][y0] is equal to 0, the syntax elements intra_luma_mpm_flag[x0][y0], intra_luma_mpm_idx[x0][y0] and intra_luma_mpm_remainder[x0][y0] specify the angular intra prediction mode for luma samples. The array indices x0, y0 specify the location (x0, y0) of the top-left luma sample of the considered coding block relative to the top-left luma sample of the picture. When intra_luma_mpm_flag[x0][y0] is equal to 1, the intra prediction mode is inferred from a neighbouring intra-predicted coding unit according to clause 8.2.2.

When intra_luma_mpm_flag[x0][y0] is not present, it is inferred to be equal to 1.

intra_chroma_pred_mode[x0][y0] specifies the intra prediction mode for chroma samples. The array indices x0, y0 specify the location (x0, y0) of the top-left luma sample of the considered coding block relative to the top-left luma sample of the picture.

8.2.2 Derivation Process for Luma Intra Prediction Mode

Input to this process are:
a luma location (xCb, yCb) specifying the top-left sample of the current luma coding block relative to the top-left luma sample of the current picture,
a variable cbWidth specifying the width of the current coding block in luma samples,
a variable cbHeight specifying the height of the current coding block in luma samples.

In this process, the luma intra prediction mode IntraPredModeY[xCb][yCb] is derived.
Table 8-1 specifies the value for the intra prediction mode IntraPredModeY[xCb][yCb] and the associated names.

TABLE 8-1
Specification of intra prediction mode and associated names

| Intra prediction mode | Associated name |
|---|---|
| 0 | INTRA_PLANAR |
| 1 | INTRA_DC |
| 2 . . . 66 | INTRA_ANGULAR2..INTRA_ANGULAR66 |
| 81 . . . 83 | INTRA_LT_CCLM, INTRA_L_CCLM, |
| | INTRA_T_CCLM |

NOTE
−: The intra prediction modes INTRA_LT_CCLM, INTRA_L_CCLM and INTRA_T_CCLM are only applicable to chroma components.

IntraPredModeY[xCb][yCb] is derived by the following ordered steps:
5. The neighbouring locations (xNbA, yNbA) and (xNbB, yNbB) are set equal to (xCb−1, yCb+cbHeight−1) and (xCb+cbWidth−1, yCb−1), respectively.
6. For X being replaced by either A or B, the variables candIntraPredModeX are derived as follows:
   The availability derivation process for a block as specified in clause 6.4.X [Ed. (BB): Neighbouring blocks availability checking process tbd] is invoked with the location (xCurr, yCurr) set equal to (xCb, yCb) and the neighbouring location (xNbY, yNbY) set equal to (xNbX, yNbX) as inputs, and the output is assigned to availableX.
   The candidate intra prediction mode candIntraPredModeX is derived as follows:
      If one or more of the following conditions are true, candIntraPredModeX is set equal to INTRA_PLANAR.
         The variable availableX is equal to FALSE.
         CuPredMode[xNbX][yNbX] is not equal to MODE_INTRA and mh_intra_flag[xNbX][yNbX] is not equal to 1.
         pcm_flag[xNbX][yNbX] is equal to 1.
         X is equal to B and yCb−1 is less than ((yCb>>Ctb Log 2SizeY)<<Ctb Log 2SizeY).
      Otherwise, candIntraPredModeX is set equal to IntraPredModeY[xNbX][yNbX].
7. The candModeList[x] with x=0 . . . 5 is derived as follows:
   If candIntraPredModeB is equal to candIntraPredModeA and candIntraPredModeA is greater than INTRA_DC, candModeList[x] with x=0 . . . 5 is derived as follows:

candModeList[0]=candIntraPredModeA (8-10)

candModeList[1]=2+((candIntraPredModeA+61)%64) (8-11)

candModeList[2]=2+((candIntraPredModeA−1)%64) (8-12)

candModeList[3]=2+((candIntraPredModeA+60)%64) (8-13)

candModeList[4]=2+(candIntraPredModeA%64) (8-14)

candModeList[5]=2+((candIntraPredModeA+59)%64) (8-15)
Otherwise if candIntraPredModeB is not equal to candIntraPredModeA and candIntraPredModeA or candIntraPredModeB is greater than INTRA_DC, the following applies:
   The variables minAB and maxAB are derived as follows:

minAB=Min(candIntraPredModeA,candIntraPredModeB) (8-16)

maxAB=Max(candIntraPredModeA,candIntraPredModeB) (8-17)
If candIntraPredModeA and candIntraPredModeB are both greater than INTRA_DC, candModeList[x] with x=0 . . . 5 is derived as follows:

candModeList[0]=candIntraPredModeA (8-18)

candModeList[1]=candIntraPredModeB (8-19)
If maxAB−minAB is equal to 1, the following applies:

candModeList[2]=2+((minAB+61)%64) (8-26)

candModeList[3]=2+((maxAB−1)%64) (8-27)

candModeList[4]=2+((minAB+60)%64) (8-28)

candModeList[5]=2+(maxAB%64) (8-29)
Otherwise if maxAB−minAB is equal to 2, the following applies:

candModeList[2]=2+((minAB−1)%64) (8-30)

candModeList[3]=2+((minAB+61)%64) (8-31)

candModeList[4]=2+((maxAB−1)%64) (8-32)

candModeList[5]=2+((minAB+60)%64) (8-33)
Otherwise if maxAB−minAB is greater than 61, the following applies:

candModeList[2]=2+((minAB−1)%64) (8-34)

candModeList[3]=2+((maxAB+61)%64) (8-35)

candModeList[4]=2+(minAB%64) (8-36)

candModeList[5]=2+((maxAB+60)%64) (8-37)
Otherwise, the following applies:

candModeList[2]=2+((minAB+61)%64) (8-38)

candModeList[3]=2+((minAB−1)%64) (8-39)

candModeList[4]=2+((maxAB+61)%64) (8-40)

candModeList[5]=2+((maxAB−1)%64) (8-41)
Otherwise (candIntraPredModeA or candIntraPredModeB is greater than INTRA_DC), candModeList[x] with x=0 . . . 5 is derived as follows:

candModeList[0]=maxAB (8-48)

candModeList[1]=2+((maxAB+61)%64) (8-49)

candModeList[2]=2+((maxAB−1)%64) (8-50)

candModeList[3]=2+((maxAB+60)%64) (8-51)

candModeList[4]=2+(maxAB%64) (8-52)

candModeList[5]=2+((maxAB+59)%64) (8-53)
Otherwise, the following applies:

candModeList[0]=INTRA_ANGULAR50 (8-60)

candModeList[1]=INTRA_ANGULAR18 (8-61)

candModeList[2]=INTRA_ANGULAR2 (8-62)

candModeList[3]=INTRA_ANGULAR34 (8-63)

candModeList[4]=INTRA_ANGULAR66 (8-64)

candModeList[5]=INTRA_ANGULAR26 (8-65)
8. IntraPredModeY[xCb][yCb] is derived by applying the following procedure:
   If intra_luma_mpm_flag[xCb][yCb] is equal to 1, the IntraPredModeY[xCb][yCb] is set equal to candModeList[intra_luma_mpm_idx[xCb][yCb] ].
   Otherwise, IntraPredModeY[xCb][yCb] is derived by applying the following ordered steps:
      3. When candModeList[i] is greater than candModeList[j] for i=0 . . . 4 and for each i, j=(i+1) . . . 5, both values are swapped as follows:

(candModeList[i],candModeList[j])=Swap(candModeList[i],candModeList[j]) (8-66)
4. IntraPredModeY[xCb][yCb] is derived by the following ordered steps:
   i. IntraPredModeY[xCb][yCb] is set equal to (intra_luma_mpm_remainder[xCb][yCb]+2).
   ii. For i equal to 0 to 5, inclusive, when IntraPredModeY[xCb][yCb] is greater than or equal to candModeList[i], the value of IntraPredModeY[xCb][yCb] is incremented by one.

The variable IntraPredModeY[x][y] with x=xCb . . . xCb+cbWidth−1 and y=yCb . . . yCb+cbHeight−1 is set to be equal to IntraPredModeY[xCb][yCb].

Embodiments of the disclosure may be configured such that when ISP is enabled, the number of intra-prediction modes that can be selected to intra-predict the resulting partitions is reduced. Embodiments of the disclosure facilitate an efficient intra-prediction mode signaling for picture coding (encoding and decoding) using ISP by removing redundancies and allow to improve intra-prediction coding.

According to a first embodiment, the following syntax for signaling the intra-prediction information may, for example, be used by decoders (and correspondingly by encoders when generating the corresponding bitstream respectively encoded picture data) instead of the one in JVET-M0528:

```
if (!intra_luma_ref_idx)
  intra_luma_angular_mode_flag
  if (!intra_luma_angular_mode_flag && ( intraSubPartitionsMode ==
NO_INTRA_SUBPARTITIONS))
    intra_luma_planar_flag
// When intraSubPartitionsMode != NO_INTRA_SUBPARTITIONS, planar mode is
inferred and intra_luma_planar_flag is not parsed
if (intra_luma_ref_idx ∥ intra_luma_angular_mode_flag)
  if (intra_luma_ref_idx)
    intra_luma_mpm_flag=1
  else
    intra_luma_mpm_flag
  if (intra_luma_mpm_flag)
    intra_luma_mpm_idx
  else
    intra_luma_mpm_remainder
```

According to a second embodiment, the following syntax for signaling the intra-prediction information may, for example, be used by decoders (and correspondingly by encoders when generating the corresponding bitstream respectively encoded picture data) instead of the one in JVET-M0210:

```
parse intra_luma_non_ang_flag
if(intra_luma_non_ang_flag == 1)
  if ( intraSubPartitionsMode == NO_INTRA_SUBPARTITIONS)
    parse intra_luma_planar_flag
  else
    intra_luma_planar_flag = 1
  IntraMode = (intra_luma_planar_flag == 1) ? Planar: DC
else
  parse intra_luma_mpm_flag
  if (intra_luma_mpm_lag)
    parse intra_luma_mpm_idx, intra_luma_ref_idx
    IntraMode = mpm1[intra_luma_mpm_idx] // MPM without Planar&DC
  else
      Parse intra_luma_mpm_remainder
      IntraMode = intra_luma_mpm_remainder
```

Embodiments of the disclosure perform a check whether ISP is applied to a current block or partition (shown as “intraSubPartitionsMode==NO_INTRA_SUBPARTITIONS” condition in the pseudo-syntax above).

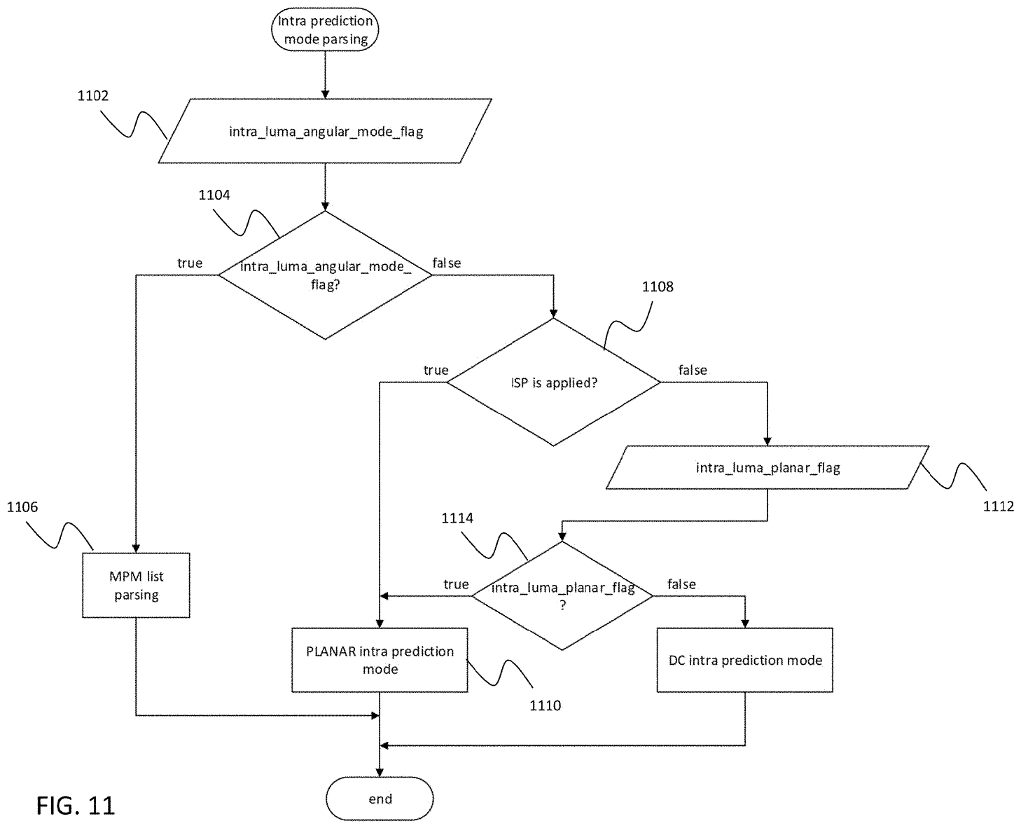

In FIG. 11, “intraSubPartitionsMode==NO_INTRA_SUBPARTITIONS” is represented as “ISP is applied” decision.

One of the embodiments is to perform a check of “intra_luma_non_ang_flag==1” and depending on whether “intra_luma_non_ang_flag” is equal to 1, perform “intraSubPartitionsMode==NO_INTRA_SUBPARTITIONS” condition check (as shown in FIG. 11).

Another embodiment is to perform “intra_luma_non_ang_flag==1” and “intraSubPartitionsMode==NO_INTRA_SUBPARTITIONS” condition checks either sequentially or in parallel and to combine the results of these checks using AND operation. If the result is true, no further parsing is performed and the value of intra prediction mode is set to PLANAR.

Otherwise, further parsing depends on “intra_luma_non_ang_flag==1” condition. If this condition is true, intra_luma_planar_flag is parsed from the stream, and otherwise MPM list parsing is done to derive one of the directional intra prediction modes.

In both above-mentioned cases, when (intraSubPartitionsMode !=NO_INTRA_SUBPARTITIONS), embodiments of the disclosure do not parse an intra_luma_planar_flag, which is instead inferred to be equal to 1, i.e. Planar mode is derived.

FIG. 11 shows a flowchart according to an embodiment of the disclosure corresponding to the above syntax examples. The steps of signaling respectively parsing of the intra prediction modes are as follows:
Step 1102: Obtain the value of the “intra_luma_angular_mode_flag”, e.g. by parsing the bitstream. This flag indicates whether obtained intra prediction mode is directional or not.
Step 1104: If the value of the flag is 1 (true), the index within the most probable modes (MPM) list is parsed (step 1106) from the bitstream, otherwise (false) a check (step 1108) is performed whether Intra sub-partitioning (ISP) is applied to the block or not.
In case that Intra sub-partitioning (ISP) is applied to the block (true), intra prediction mode is set to PLANAR intra prediction (step 1110), i.e. the intra prediction mode is inferred and not parsed from the bitstream.
In case that ISP is not applied to the block (false), the intra prediction mode is determined on the basis of additional signaling (step 1112), e,g, based on a flag indicating whether DC or Planar mode is used for the block, such as the flag “intra_luma_planar_flag” (step 1114).

Other embodiments may use other flags, e.g. “intra_luma_non_angular_mode_flag” with inverse mapping of values to the groups of modes compared to the “intra_luma_angular_mode_flag”, to indicate whether the block is directional (or angular) or not (e.g. Planar or DC mode).

In other words, FIG. 11 shows a flowchart according to an embodiment of the disclosure corresponding to the above syntax examples. The steps of signaling respectively parsing of the intra prediction modes are as follows:
Step 1102: Obtaining the value of the flag “intra_luma_angular_mode_flag”, e.g. by parsing the bitstream. This flag indicates whether the intra prediction mode of a block (to be decoded) is directional or not.
Step 1104: If the value of the “intra_luma_angular_mode_flag” is true, i.e. nonzero, e.g. intra_luma_angular_mode_flag is equal to 1, the index within the most probable modes (MPM) list is parsed, see step 1106, from the bitstream, otherwise (i.e. if the value of the “intra_luma_angular_mode_flag” is false, i.e. zero, e.g. intra_luma_angular_mode_flag is equal to 0), a check, see step 1108, is performed whether Intra sub-partitioning (ISP) is applied to the block or not.
In case that Intra sub-partitioning, ISP, is applied to the block, i.e. step 1108 is evaluated to be true, the intra prediction mode is set to PLANAR intra prediction, see step 1110, i.e. the intra prediction mode is inferred and not parsed from the bitstream.
In case that ISP is not applied to the block, i.e. step 1108 is evaluated to be false, the intra prediction mode is determined on the basis of additional signaling, see step 1112, e,g, based on a flag indicating whether DC or Planar mode is used for the block, such as the flag “intra_luma_planar_flag”, see step 1114.

Embodiments of the present disclosure provide an alternative to signaling of intra-prediction information, for example, to be used by decoders and correspondingly encoders when generating the corresponding bitstream instead of the signaling as described in JVET-M0210 or JVET-M0528.

Embodiments of methods for encoding an intra-prediction mode a block of a picture, e.g. implemented by a encoding device, comprise the corresponding features to add intra-prediction information, e.g. in form of flags or other syntax elements, to the bitstream such that—as defined for the decoding method—the intra-prediction information can be directly parsed or inferred from the bit stream by embodiments of the decoding method or corresponding decoders.

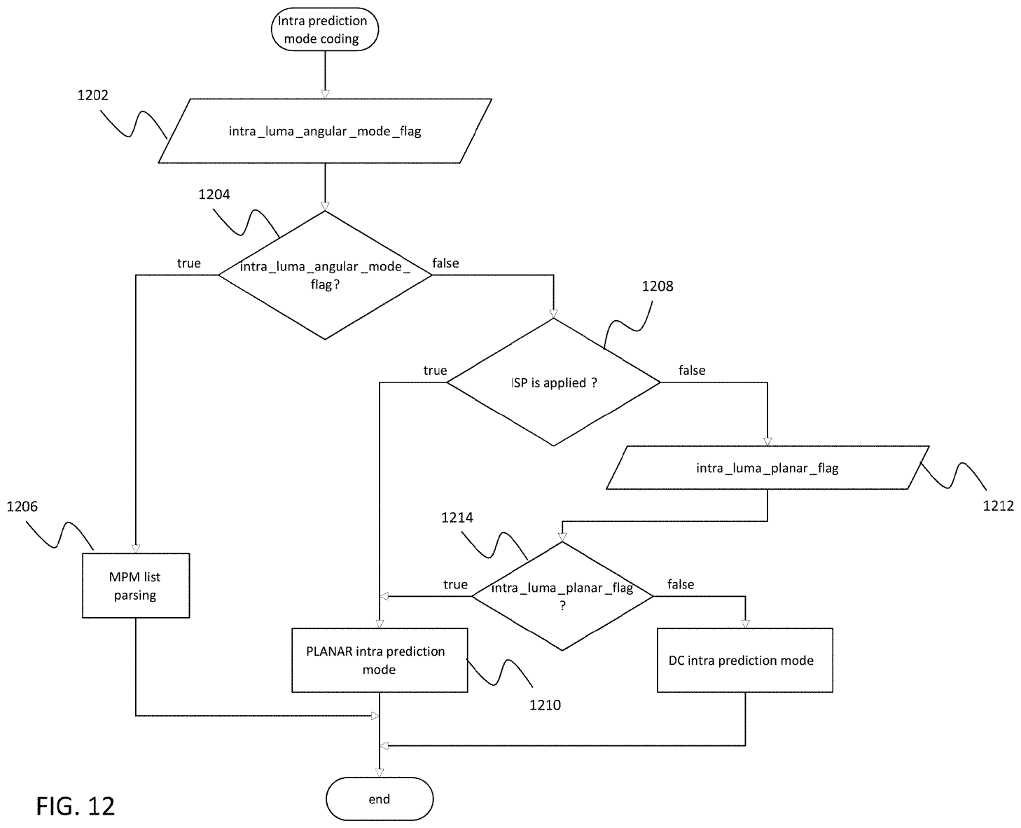

Further, FIG. 12 shows a flowchart according to an embodiment of the disclosure corresponding to the above syntax examples. The steps of coding an intra prediction mode for a block of a picture into a bitstream are as follows:
Step 1202: Obtaining the value of the flag “intra_luma_angular_mode_flag”, e.g. by parsing the bitstream. This flag indicates whether the intra prediction mode of a block (to be encoded) is directional or not.
Step 1204: If the value of the “intra_luma_angular_mode_flag” is true, i.e. nonzero, e.g. intra_luma_angular_mode_flag is equal to 1, encoding an index value within a most probable modes, MPM, list into the bitstream, i.e. step 1206, otherwise (i.e. if the value of the “intra_luma_angular_mode_flag” is false, i.e. zero, e.g. intra_luma_angular_mode_flag is equal to 0), a check, see step 1208, is performed whether Intra sub-partitioning (ISP) is applied to the block or not.
In case that Intra sub-partitioning, ISP, is applied to the block, i.e. step 1208 is evaluated to be true, the intra prediction mode is set to PLANAR intra prediction, see step 1210, i.e. the intra prediction mode is inferred and not parsed from the bitstream.
In case that ISP is not applied to the block, i.e. step 1208 is evaluated to be false, the intra prediction mode is encoded on the basis of additional signaling, see step 1212, or otherwise, in case ISP is applied to the block, the intra prediction mode for the block is set to PLANAR intra prediction, see step 1214.

Here, for FIG. 12, the additional signaling may be used to signal the intra prediction mode by signaling the value of the additional flag denoted “intra_luma_planar_flag” when ISP is not applied to the block.

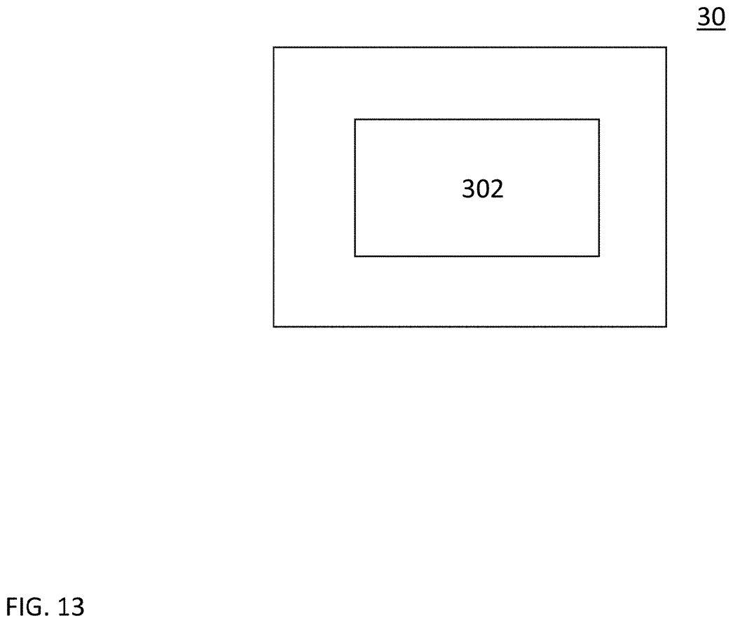

FIG. 13 illustrates an embodiment of decoder 30 for determining an intra-prediction mode for decoding a block of a picture encoded in a bitstream, comprising: an inferring unit 302 for inferring a value of an intra-prediction mode of the block to a value indicating a non-angular mode in case prediction information associated with the block indicates that the intra-prediction mode is not an angular mode and that Intra-sub-partitioning, ISP, is applied to the block.

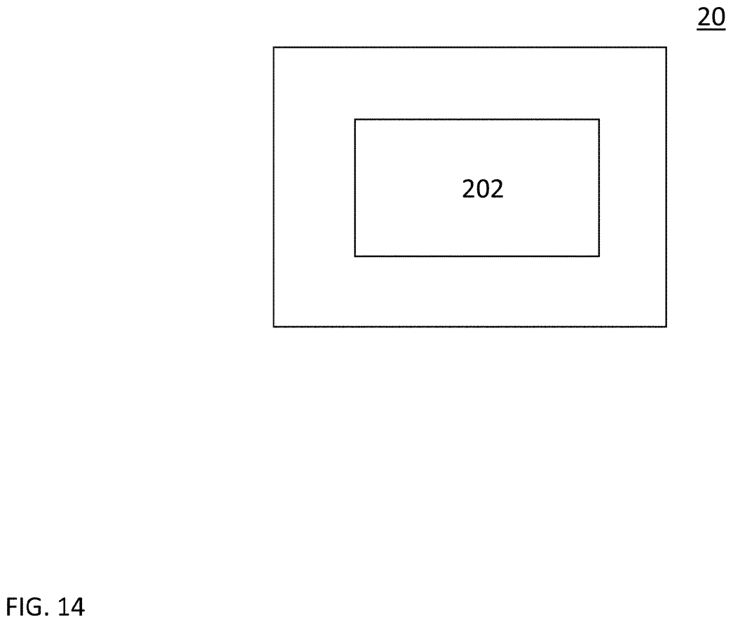

FIG. 14 illustrates an embodiment of an encoder 20 for determining an intra-prediction mode for decoding a block of a picture encoded in a bitstream, comprising an inferring unit 202 for inferring a value of an intra-prediction mode of the block to a value indicating a non-angular mode in case prediction information associated with the block indicates that the intra-prediction mode is not an angular mode and that Intra-sub-partitioning, ISP, is applied to the block.

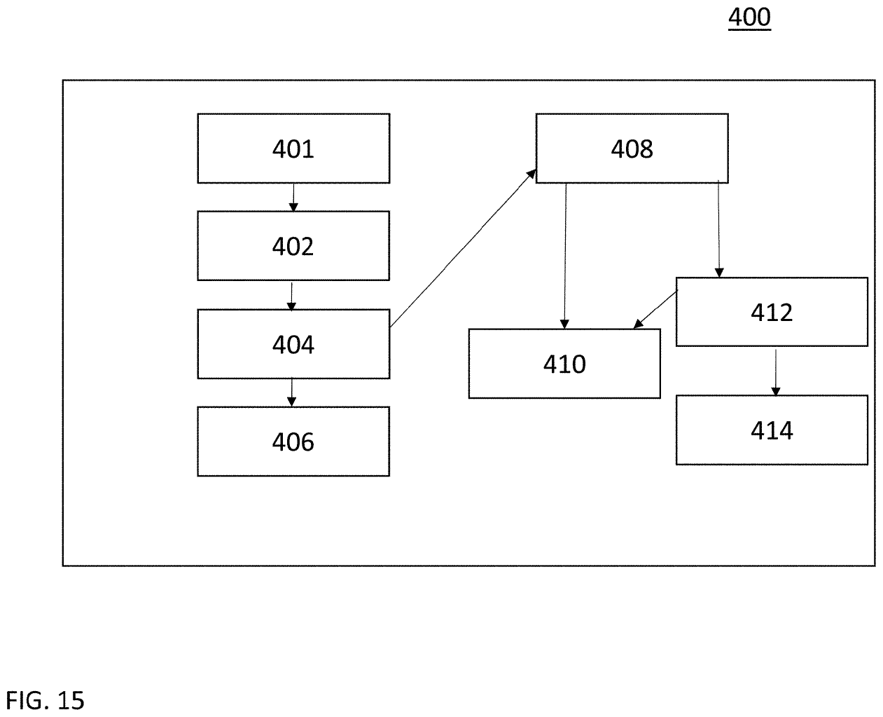

Corresponding to FIG. 11, FIG. 15 schematically depicts a coding device 400, comprising a parsing unit 401 for parsing a bitstream for an intra prediction mode for decoding a block of a picture encoded in the bitstream. The coding device 400 further comprises a first obtaining unit 402 for obtaining a value of a flag denoted “intra_luma_angular_mode_flag” from the bitstream, a first determining unit 404 for determining that value of the flag indicates whether the intra prediction mode obtained by parsing the bitstream and used to intra-predict the block is a directional intra-prediction mode or not; a second obtaining unit 406 for obtaining an index value within a most probable modes, MPM, list in case the value of the flag “intra_luma_angular_mode_flag” is nonzero; otherwise in case the first determining unit 404 has determined the value of the flag “intra_luma_angular_mode_flag” is zero: a second determining unit 408 for determining whether intra sub-partitioning, ISP, is applied to the block, and in case ISP is not applied to the block: a third obtaining unit 412 for obtaining an “intra_luma_planar_flag”, and a second determining unit 414 for determining the intra prediction mode on the basis of additional signaling, or otherwise, in case ISP is applied to the block, a setting unit for setting the intra prediction mode for the block set to PLANAR intra prediction.

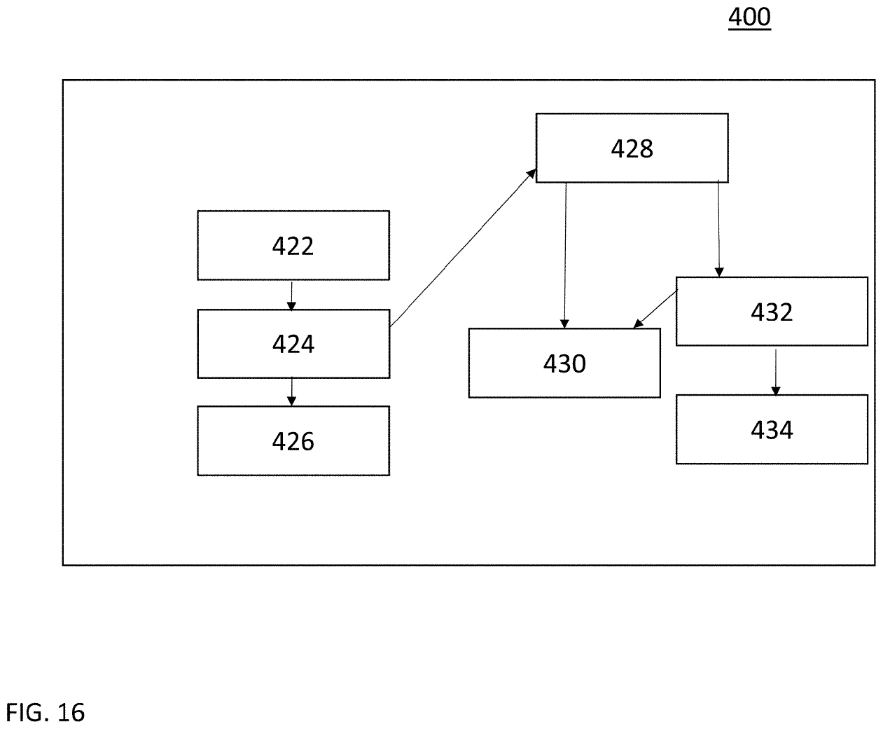

Corresponding to FIG. 12, FIG. 16 schematically depicts a coding device 400 for coding an intra prediction mode of a block of a picture in a bitstream, the coding device comprising: a first encoding unit 422 for encoding a value of a flag denoted “intra_luma_angular_mode_flag” into the bitstream, a first determining unit 424 for determining that the value of the flag indicates whether the intra prediction mode used to intra-predict the block is a directional intra-prediction mode or not; a second encoding unit 426 for encoding an index value within a most probable modes, MPM, list into the bitstream, in case the value of the flag “intra_luma_angular_mode_flag” is nonzero, otherwise in case the first determining unit 424 has determined the value of the flag “intra_luma_angular_mode_flag” is zero: a second determining unit 428 for determining whether intra sub-partitioning, ISP, is applied to the block, and in case ISP is not applied to the block, an obtaining unit 432 for obtaining an “intra_luma_planar_flag”, and a third encoding unit 434 for encoding the intra prediction mode on the basis of additional signaling, or otherwise, in case ISP is applied to the block, a setting unit 430 for setting the intra prediction mode for the block to PLANAR intra prediction.

In another embodiment, determination of whether ISP is applied to the block is performed on the base of signaling within a bitstream. For example, a flag may be encoded indicating whether ISP should be applied to the block in order to get the values of reconstructed samples.

In another embodiment, additional signaling may be implemented as specified in JVET-M0528. For example, the value of “intra_luma_planar_flag” is obtained from the bitstream. The value of this flag indicates whether a block is predicted using PLANAR or DC intra prediction mode.

Mathematical Operators

The mathematical operators used in this application are similar to those used in the C programming language. However, the results of integer division and arithmetic shift operations are defined more precisely, and additional operations are defined, such as exponentiation and real-valued division. Numbering and counting conventions generally begin from 0, e.g., “the first” is equivalent to the 0-th, “the second” is equivalent to the 1-th, etc.

Arithmetic Operators

The following arithmetic operators are defined as follows:
+ Addition
− Subtraction (as a two-argument operator) or negation (as a unary prefix operator)
* Multiplication, including matrix multiplication
x^{y} Exponentiation. Specifies x to the power of y. In other contexts, such notation is used for superscripting not intended for interpretation as exponentiation.
/ Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.

$$\frac{x}{y}$$

Used to denote division in mathematical equations where no truncation or rounding is intended.

$${\sum }_{i = x}^{y} f ( i )$$

The summation of f(i) with i taking all integer values from x up to and including y. Modulus. Remainder of x divided by y, defined only for integers x and y with x>=0
x%y and y>0.

Logical Operators

The following logical operators are defined as follows:
x && y Boolean logical “and” of x and y
x∥y Boolean logical “or” of x and y
! Boolean logical “not”
x?y:z If x is TRUE or not equal to 0, evaluates to the value of y; otherwise, evaluates to the value of z.

Relational Operators

The following relational operators are defined as follows:
> Greater than
>= Greater than or equal to
< Less than
<= Less than or equal to
== Equal to
!= Not equal to

When a relational operator is applied to a syntax element or variable that has been assigned the value “na” (not applicable), the value “na” is treated as a distinct value for the syntax element or variable. The value “na” is considered not to be equal to any other value.

Bit-Wise Operators

The following bit-wise operators are defined as follows:
& Bit-wise “and”. When operating on integer arguments, operates on a two's complement representation of the integer value. When operating on a binary argument that contains fewer bits than another argument, the shorter argument is extended by adding more significant bits equal to 0.
   | Bit-wise “or”. When operating on integer arguments, operates on a two's complement representation of the integer value. When operating on a binary argument that contains fewer bits than another argument, the shorter argument is extended by adding more significant bits equal to 0.
\hat{ } Bit-wise “exclusive or”. When operating on integer arguments, operates on a two's complement representation of the integer value. When operating on a binary argument that contains fewer bits than another argument, the shorter argument is extended by adding more significant bits equal to 0.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

Assignment Operators

The following arithmetic operators are defined as follows:

$$= Assignment operator \\ ++ Increment , i . e . , x ++ is equivalent to x = x + 1 ; when used in an array index , evaluates to the value of the variable prior to the increment operation . \\ -- Decrement , i . e . , x -- is equivalent to x = x - 1 ; when used in an array index , evaluates to the value of the variable prior to the decrement operation . \\ += Increment by amount specified , i . e . , x += 3 is equivalent to x = x + 3 , and x += ( - 3 ) is equivalent to x = x + ( - 3 ) . \\ -= Decrement by amount specified , i . e . , x -= 3 is equivalent to x = x - 3 , and x -= ( - 3 ) is equivalent to x = x - ( - 3 ) .$$

Range Notation

The following notation is used to specify a range of values:

x=y . . . z x takes on integer values starting from y to z, inclusive, with x, y, and z being integer numbers and z being greater than y.

Mathematical Functions

The following mathematical functions are defined:

$$Abs ( x ) = \{ \begin{matrix}x & ; & x >= 0 \\ - x & ; & x < 0\end{matrix}$$

A sin(x) the trigonometric inverse sine function, operating on an argument x that is in the range of −1.0 to 1.0, inclusive, with an output value in the range of −π÷2 to π÷2, inclusive, in units of radians
A tan(x) the trigonometric inverse tangent function, operating on an argument x, with an output value in the range of −π÷2 to π÷2, inclusive, in units of radians

$$A tan 2 ( y , x ) = \{ \begin{matrix}A tan ( \frac{y}{x} ) & ; & x > 0 \\ A tan ( \frac{y}{x} ) + π & ; & x < 0 \&\& y >= 0 \\ A tan ( \frac{y}{x} ) - π & ; & x < 0 \&\& y < 0 \\ + \frac{π}{2} & ; & x == 0 \&\& y >= 0 \\ - \frac{π}{2} & ; & otherwise\end{matrix}$$

Ceil(x) the smallest integer greater than or equal to x.
Clip1_{Y}(x)=Clip3(0, (1<<BitDepth_{Y})−1, x)
Clip1_{C}(x)=Clip3(0, (1<<BitDepth_{C})−1, x)

$$Clip 3 ( x , y , z ) = \{ \begin{matrix}x & ; & z < x \\ y & ; & z > y \\ z & ; & otherwise\end{matrix}$$

Cos(x) the trigonometric cosine function operating on an argument x in units of radians.
Floor(x) the largest integer less than or equal to x.

$$GetCurrMsb ( a , b , c , d ) = \{ \begin{matrix}c + d & ; & b - a >= d / 2 \\ c - d & ; & a - b > d / 2 \\ c & ; & otherwise\end{matrix}$$

Ln(x) the natural logarithm of x (the base-e logarithm, where e is the natural logarithm base constant 2.718 281 828 . . . ).
Log 2(x) the base-2 logarithm of x.
Log 10(x) the base-10 logarithm of x.

$$Min ( x , y ) = \{ \begin{matrix} x & ; & x <= y \\ y & ; & x > y\end{matrix} \\ Max ( x , y ) = \{ \begin{matrix} x & ; & x >= y \\ y & ; & x < y\end{matrix}$$

Round(x)=Sign(x)*Floor(Abs(x)+0.5)

$$Sign ( x ) = \{ \begin{matrix}1 & ; & x > 0 \\ 0 & ; & x == 0 \\ - 1 & ; & x < 0\end{matrix}$$

Sin(x) the trigonometric sine function operating on an argument x in units of radians
Sqrt(x)=\sqrt{x}
Swap(x, y)=(y, x)
Tan(x) the trigonometric tangent function operating on an argument x in units of radians

Order of Operation Precedence

When an order of precedence in an expression is not indicated explicitly by use of parentheses, the following rules apply:
Operations of a higher precedence are evaluated before any operation of a lower precedence.
Operations of the same precedence are evaluated sequentially from left to right.

The table below specifies the precedence of operations from highest to lowest; a higher position in the table indicates a higher precedence.

For those operators that are also used in the C programming language, the order of precedence used in this Specification is the same as used in the C programming language.

TABLE

Operation precedence from highest (at top of table)
to lowest (at bottom of table)
operations (with operands x, y, and z)
“x++”, “x− −”
“!x”, “−x” (as a unary prefix operator)
x^{y}
$“ x * y ” , “ x / y ” , “ x \div y ” , “ \frac{x}{y} ” , “ x \% y ”$
“x + y”, “x − y” (as a two-argument operator), ”
${\sum }_{i = x}^{y} f ( i ) ”$
“x << y”, “x >> y”
“x < y”, “x <= y”, “x > y”, “x >= y”
“x = = y”, “x != y”
“x & y”
“x | y”
“x && y”
“x || y”
“x ? y : z”
“x . . . y”
“x = y”, “x += y”, “x −= y”

Text Description of Logical Operations

In the text, a statement of logical operations as would be described mathematically in the following form:

```
if( condition 0 )
  statement 0
else if( condition 1 )
  statement 1
...
else /* informative remark on remaining condition */
  statement n
```

may be described in the following manner:
   . . . as follows / . . . the following applies:
   If condition 0, statement 0
   Otherwise, if condition 1, statement 1
   . . .
   Otherwise (informative remark on remaining condition), statement n

Each “If . . . Otherwise, if . . . Otherwise, . . . ” statement in the text is introduced with “ . . . as follows” or “ . . . the following applies” immediately followed by “If . . . ”. The last condition of the “If . . . Otherwise, if . . . Otherwise, . . . ” is always an “Otherwise, . . . ”. Interleaved “If . . . Otherwise, if . . . Otherwise, . . . ” statements can be identified by matching “ . . . as follows” or “ . . . the following applies” with the ending “Otherwise, . . . ”.

In the text, a statement of logical operations as would be described mathematically in the following form:

| | | |
|---|---|---|
| if( condition 0a | && | condition 0b ) |
| statement 0 | | |
| else if( condition 1a | ∥ | condition 1b ) |
| statement 1 | | |
| ... | | |
| else | | |
| statement n | | |

may be described in the following manner:
. . . as follows / . . . the following applies:
   If all of the following conditions are true, statement 0:
   condition 0a
   condition 0b
   Otherwise, if one or more of the following conditions are true, statement 1:
   condition 1a
   condition 1b
   . . .
   Otherwise, statement n

In the text, a statement of logical operations as would be described mathematically in the following form:

```
if( condition 0 )
  statement 0
if( condition 1 )
  statement 1
```

may be described in the following manner:
   When condition 0, statement 0
   When condition 1, statement 1

Although embodiments of the disclosure have been primarily described based on video coding, it should be noted that embodiments of the coding system 10, encoder 20 and decoder 30 (and correspondingly the system 10) and the other embodiments described herein may also be configured for still picture processing or coding, i.e. the processing or coding of an individual picture independent of any preceding or consecutive picture as in video coding. In general, only inter-prediction units 244 (encoder) and 344 (decoder) may not be available in case the picture processing coding is limited to a single picture 17. All other functionalities (also referred to as tools or technologies) of the video encoder 20 and video decoder 30 may equally be used for still picture processing, e.g. residual calculation 204/304, transform 206, quantization 208, inverse quantization 210/310, (inverse) transform 212/312, partitioning 262/362, intra-prediction 254/354, and/or loop filtering 220, 320, and entropy coding 270 and entropy decoding 304.

Embodiments, e.g. of the encoder 20 and the decoder 30, and functions described herein, e.g. with reference to the encoder 20 and the decoder 30, may be implemented in hardware, software, firmware, or any combination thereof. If implemented in software, the functions may be stored on a computer-readable medium or transmitted over communication media as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limiting, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

The present disclosure provides the following further aspects.

In a first aspect of a method for determining an intra-prediction mode for decoding a block of a picture, e.g. implemented by a decoding device, the method includes: inferring (or setting) a value of an intra-prediction mode of the block to a value indicating (or representing) a Planar mode, when prediction information associated to the block indicates that the intra-prediction mode is not an angular mode and that Intra-sub-partitioning (ISP) is applied to the block. (may use determining, obtaining, calculating, computing, etc.)

According to these aspects, the value of the intra-prediction mode may under these conditions be inferred and not parsed directly from the bit stream.

The prediction information may comprise or may be, e.g., a flag parsed from the bitstream, or may be derived from other parameters in the bitstream.

The flag may be an angular mode flag such as the “intra_luma_angular_mode_flag”, for which, e.g., a value one indicates angular mode and a value zero indicates not angular mode (e.g. Planar or DC mode), or the “intra_luma_non_angular_flag”, for which, e.g., a value zero indicates angular mode and a value one indicates not angular mode (e.g. Planar or DC mode), i.e. inverse assignment of values compared to the “intra_luma_angular_mode_flag”.

These aspects may also infer another intra-prediction mode than the Planar mode, e.g. the DC mode instead.

In a second aspect of a method of the first aspect, the method further includes: decoding the block based on the inferred value of the intra-prediction mode, i.e. using Planar mode.

In a third aspect of a method according to any one of the first and second aspects, the prediction information indicating that the intra-prediction mode is an angular mode is a flag indicating whether the intra-prediction mode of the block is a directional mode or not.

In a fourth aspect of a method according to any one of the first to third aspects, the method further comprises: parsing an angular mode flag from a bitstream associated to the block to obtain the prediction information, wherein the angular mode flag indicates, whether the intra-prediction mode of the block is a directional mode or not.

In a fifth aspect of a method according to any one of the first to fourth aspects, the method further comprises: determining whether ISP is applied to the block or not.

In a sixth aspect of a method according to any one of the first to fifth aspects, the method further includes: inferring (not parsing from the bitstream) the prediction information indicating whether ISP is applied to the block based on prediction information indicating whether multiple reference line (MRL) prediction is applied to the block.

In a seventh aspect of a method according to any one of the first to sixth aspects, inferring (not parsing from the bitstream) that intra-sub-partitioning (ISP) is not applied to the block when MRL prediction is applied to the block.

In an eighth aspect of a method according to any one of the first to seventh aspects, the method further includes parsing a flag indicating whether ISP is applied to the block or not to obtain the prediction information whether ISP is applied to the block or not.

In a ninth aspect of a method according to any one of the first to eighth aspects, the method further includes:
parsing a flag from a bitstream associated to the block indicating whether a planar mode or a DC mode is applied to the block when the prediction information indicates that ISP is not applied to the block.

According to these aspects, the flag may be, e.g. a “intra_luma_planar_flag”, wherein a value one may indicate the Planar mode and a value zero may indicate the DC mode. Other aspects may use flags with inverse associations of these values to these two modes.

In a tenth aspect of a method according to any one of the first to ninth aspects, the method further includes: obtaining the value of the intra prediction mode from a most probable modes (MPM) list when the prediction information associated to the block indicates that the intra-prediction mode is an angular mode.

The method may further comprise decoding the block using the obtained value of the intra prediction mode.

In an eleventh aspect according to any one of the first to tenth aspects, the method comprises: (i) determining that the prediction information associated to the block indicates that the intra-prediction mode is not an angular mode and that Intra-sub-partitioning (ISP) is applied to the block at one or in parallel; or (ii) determining first that the prediction information associated to the block indicates that the intra-prediction mode is not an angular mode, and afterwards determining that Intra-sub-partitioning (ISP) is applied to the block.

Aspects of methods for encoding an intra-prediction mode of a block of a picture, e.g. implemented by a encoding device, may comprise the corresponding features to add intra-prediction information, e.g. in form of flags or other syntax elements, to the bitstream such that—as defined for the decoding method—the intra-prediction information can be directly parsed or inferred from the bit stream by embodiments of the decoding method or corresponding decoders.

In a twelfth aspect of a method of coding implemented by a decoding device, comprising parsing intra prediction mode for the block, the method comprises: obtaining the value of “intra_luma_angular_mode_flag” from the bitstream, that indicates whether obtained intra prediction mode used to intra-predict the block is directional or not; obtaining the index value within the most probable modes (MPM) list when the value of “intra_luma_angular_mode_flag” is nonzero; determining whether intra sub-partitioning (ISP) is applied to the block, and when ISP is not applied to the block, intra prediction mode is determined on the basis of additional signaling, or otherwise, when ISP is applied to the block, intra prediction mode for the block is set to PLANAR intra prediction.

In a thirteenth aspect of a method of coding implemented by an encoding device, comprising coding intra prediction mode for the block, the method comprises: encoding the value of “intra_luma_angular_mode_flag” into the bitstream, that indicates whether intra prediction mode used to intra-predict the block is directional or not; Encoding the index value within the most probable modes (MPM) list into the bitstream, when the value of “intra_luma_angular_mode_flag” is nonzero; determining whether intra sub-partitioning (ISP) is applied to the block, and when ISP is not applied to the block, intra prediction mode is encoded on the basis of additional signaling, or otherwise, when ISP is applied to the block, intra prediction mode for the block is restricted to PLANAR intra prediction.

In a fourteenth aspect of a method according to any one of the twelfth to thirteenth aspects, a flag is encoded indicating whether ISP should be applied to the block in order to get the values of reconstructed samples, and determination of whether ISP is applied to the block is performed on the base of signaling within a bitstream.

In a fifteenth aspect of a method according to any one of the twelfth to fourteenth aspects, the additional signaling is used to signal intra prediction mode by signaling the value of “intra_luma_planar_flag” when ISP is not applied to the block.

In a sixteenth aspect of a method according to any one of the twelfth to fifteenth aspects, when MRL is applied to the block and ISP is not applied to the block, ISP flag is not signaled in the bitstream.

In a seventeenth aspect, an encoder includes processing circuitry for carrying out the method according to any one of the thirteenth to sixteenth aspect and any embodiment described herein.

In an eighteenth aspect, a decoder includes processing circuitry for carrying out the method according to any one of the first to twelfth and fourteenth to sixteenth aspects and any embodiment described herein.

In a nineteenth aspect, a computer program product includes a program code for performing the method according to any one of the first to sixteenth aspects and any embodiment described herein.

In a twentieth aspect, a decoder, includes: one or more processors; and a non-transitory computer-readable storage medium coupled to the processors and storing programming for execution by the processors, wherein the programming, when executed by the processors, configures the decoder to carry out the method according to any one of of the first to twelfth and fourteenth to sixteenth aspects and any embodiment described herein.

In a twenty-first aspect, an encoder includes: one or more processors; and a non-transitory computer-readable storage medium coupled to the processors and storing programming for execution by the processors, wherein the programming, when executed by the processors, configures the encoder to carry out the method according to any one of any one of the thirteenth to sixteenth aspect and any embodiment described herein.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

1. A method for determining an intra-prediction mode for decoding a block of a picture encoded in a bitstream, the method comprising:
inferring a value of the intra-prediction mode of the block to a value indicating a non-angular mode in a case where prediction information associated with the block indicates that the intra-prediction mode is not an angular mode and that intra-sub-partitioning (ISP) is applied to the block.

2. The method according to claim 1, wherein the prediction information comprises or consists of a flag parsed from the bitstream, or is derived from other parameters in the bitstream.

3. The method according to claim 2,
wherein the flag indicates the presence or absence of an angular mode, respectively;
wherein the flag is denoted “intra_luma_angular_mode_flag”, and
wherein for the flag, a value of one indicates an angular mode and a value of zero indicates a non-angular mode; or the value of zero indicates an angular mode and a value of one indicates a non_angular mode.

4. The method according to claim 1, wherein the intra-prediction mode is the Planar mode, or the DC mode.

5. The method of claim 1, wherein the prediction information indicating that the intra-prediction mode is an angular mode is a flag indicating whether the intra-prediction mode of the block is an angular mode or not.

6. The method of claim 1, wherein the method further comprises:
determining whether ISP is applied to the block or not.

7. The method of claim 1, the method further comprising:
inferring the prediction information indicating whether ISP is applied to the block based on the prediction information indicating whether multiple reference line (MRL) prediction is applied to the block; or
parsing a flag from the bitstream indicating whether ISP is applied to the block or not to obtain the prediction information whether ISP is applied to the block or not.

8. The method of claim 1, further comprising:
parsing a flag from the bitstream associated to the block indicating whether a planar mode or a DC mode is applied to the block in a condition where the prediction information indicates that ISP is not applied to the block;
wherein the flag is denoted “intra_luma_planar_flag”, and
wherein a value one of the flag indicates the Planar mode and a value zero indicates the DC mode.

9. The method of claim 1, further comprising:
obtaining the value of the intra prediction mode from a most probable modes (MPM) list in a case where the prediction information associated to the block indicates that the intra-prediction mode is an angular mode.

10. The method of claim 1, wherein the method comprises:
determining that the prediction information associated to the block indicates that the intra-prediction mode is not an angular mode and that ISP is applied to the block at once or in parallel; or
determining first that the prediction information associated to the block indicates that the intra-prediction mode is not an angular mode, and afterwards determining that ISP is applied to the block.

11. A method of coding implemented by a decoding device, the method comprising:
parsing a bitstream for an intra prediction mode for decoding a block of a picture encoded in the bitstream,
obtaining a value of a flag from the bitstream, wherein that value of the flag indicates whether the intra prediction mode obtained by parsing the bitstream and used to intra-predict the block is an angular intra-prediction mode or not;
obtaining an index value within a most probable modes (MPM) list in a case where the value of the flag is nonzero;
otherwise in a case where the value of the flag is zero:
determining whether intra sub-partitioning (ISP) is applied to the block, and
in a case where ISP is not applied to the block, the intra prediction mode is determined on the basis of additional signaling, or otherwise,
in case ISP is applied to the block, the intra prediction mode for the block is set to Planar intra prediction.

12. A method for coding an intra prediction mode of a block of a picture into a bitstream, implemented by an encoding device, the method comprising:
encoding a value of a flag into the bitstream, wherein that value of the flag indicates whether the intra prediction mode used to intra-predict the block is an angular intra-prediction mode or not;
encoding an index value within a most probable modes (MPM) list into the bitstream, in a case where the value of the flag is nonzero;
otherwise, in a case where the value of the flag is zero:
determining whether intra sub-partitioning (ISP) is applied to the block, and
in a case where ISP is not applied to the block, the intra prediction mode is encoded on the basis of additional signaling, or otherwise,
in a case where ISP is applied to the block, the intra prediction mode for the block is set to Planar intra prediction.

13. A non-transitory computer readable storage medium comprising a program code for performing the method according to claim 1.

14. A decoder, comprising:
one or more processors; and
a non-transitory computer-readable storage medium coupled to the one or more processors and storing programming for execution by the one or more processors, wherein the programming, when executed by the one or more processors, configures the decoder to carry out the method according to claim 1.

15. An encoder, comprising:
one or more processors; and
a non-transitory computer-readable storage medium coupled to the one or more processors and storing programming for execution by the one or more processors, wherein the programming, when executed by the one or more processors, configures the encoder to carry out the method according to claim 12.
